(19) United States
(12) Patent Application Publication
(10) Pub. No.: US 2008/0017576 A1
(43) Pub. Date: Jan. 24, 2008

(54) GLOBAL MODEL FOR OPTIMIZING CROSSFLOW MICROFILTRATION AND ULTRAFILTRATION PROCESSES

(75) Inventors: Georges Belfort, Slingerlands, NY (US); Gautam Lal Baruah, Vernon Hills, IL (US); Adith Venkiteshwaran, Troy, NY (US)

Correspondence Address: NIXON PEABODY LLP - PATENT GROUP, CLINTON SQUARE, P.O. BOX 31051, ROCHESTER, NY, 14603-1051, US

(73) Assignee: RENSSELAER POLYTECHNIC INSTITUTE, Troy, NY (US)

(21) Appl. No.: 11/760,407

(22) Filed: Jun. 8, 2007

Related U.S. Application Data
(60) Provisional application No. 60/813,897, filed on Jun. 15, 2006.

(51) Int. Cl. B01D 61/14; G06F 19/00

(52) U.S. Cl. 210/641; 702/26

(57) ABSTRACT

The present invention is a method for optimizing operating conditions for yield, purity, or selectivity of target species, and/or processing time for crossflow membrane filtration of target species in feed suspensions. This involves providing as input parameters: size distribution and concentration of particles and solutes in the suspension; suspension pH and temperature; physical and operating properties of membranes, and number and volume of reservoirs. The method also involves determining effective membrane pore size distribution; suspension viscosity, hydrodynamics, and electrostatics; pressure-independent permeation flux of the suspension and cake composition; pressure-independent permeation flux for each particle and overall observed sieving coefficient of each target species through cake deposit and pores; solving mass balance equations for all solutes; and iterating the mass balance equation for each solute at all possible permeation fluxes, thereby optimizing operating conditions. The invention also provides a computer readable medium for carrying out the method of the present invention.

This application claims the benefit of U.S. Provisional Patent Application Ser. No. 60/813,897, filed Jun. 15, 2006, which is hereby incorporated by reference in its entirety.

This invention was developed with government funding under the U.S. Department of Energy (Grant DEFG02-90ER14114) and the National Science Foundation (Grant CTS-94-00610). The U.S. Government may retain certain rights.

### FIELD OF THE INVENTION

The present invention relates to a global model for optimizing laminar crossflow microfiltration and ultrafiltration processes for yield, purity, selectivity, and/or diafiltration processing time of polydisperse suspensions and solutions.

### BACKGROUND OF THE INVENTION

Pressure-driven membrane processes such as micro-filtration (MF) and ultrafiltration (UF) are vital unit operations that are ubiquitous in many processing industries such as the biotechnology, pharmaceutical, food and beverage, and paint industries. MF and UF compete with depth filtration, centrifugation, and chromatography for the capture and purification of numerous products in the biotechnology industry. The present era of genomics and proteomics has ushered in a large number of protein products and many more are in the pipeline. Hence, it is most important to optimize and streamline separation and recovery processes such as MF/UF for operation and design.

Prior to the past decade, MF and UF processes were analogous to size-exclusion chromatography and were considered to be based on steric hindrance and exclusion only. Other limitations to resolution were wide pore size distributions, concentration polarization, and membrane fouling. These limitations meant that membrane separations were restricted to solutes differing in size by about an order of magnitude (van Reis et al., “High Performance Tangential Flow Filtration,” Biotechnol. Bioeng 56:71-82 (1997); Cherkasov et al., “The Resolving Power of Ultrafiltration,” J Membr Sci 110:79-82 (1996); DiLeo et al., “High-Resolution Removal of Virus from Protein Solutions Using a Membrane of Unique Structure,” Bio/Technology 10:182-188 (1992)) and could not be used for protein fractionation. Thus, in the biotechnology industry, MF was used for protein and cell recovery from cell suspensions and UF was used for protein concentration and buffer exchange.

Electrostatics. In the past decade, a number of researchers (van Reis et al., “High Performance Tangential Flow Filtration,” Biotechnol. Bioeng 56:71-82 (1997); Muller, et al., “Ultrafiltration Modes of Operation for the Separation of R-Lactalbumin from Acid Casein Whey,” J Membr Sci 153:9-21 (1999); Rabiller-Baudry et al., “Application of a Convection-Diffusion-Electrophoretic Migration Model to Ultrafiltration of Lysozyme at Different pH Values and Ionic Strengths,” J Membr Sci 179:163-174 (2000); Nystrom et al., “Fractionation of Model Proteins Using Their Physicochemical Properties,” Colloids Surf 138:185-205 (1998)) have added a dimension to membrane separations by utilizing long range electrostatic interactions between colloidal solutes, analogous to ion-exchange chromatography. The idea is to operate the process at the pI of the transmitted protein and far away from the pI of the retained protein. To enhance the separation, the ionic strength is kept low so that the thickness of the diffuse double layer of the charged solute is pronounced, leading to high retention, whereas the uncharged solute readily permeates through the membrane. To minimize the effect of concentration polarization, these separations were conducted in the pressure-dependent regime (i.e., at relatively low transmembrane pressures). High selectivities (e.g., in the region of 70) have been achieved for binary solutions such as bovine serum albumen-IgG (BSA-IgG) and bovine serum hemoglobin (BSA-Hb). For the case of BSA-IgG, separation was, in fact, obtained against the size gradient by operating at the pI (isoelectric point) of IgG with a 300 kDa membrane (Saksena et al., “Effect of Solution pH and Ionic Strength on the Separation of Albumin from Immunoglobulin-(IgG) by Selective Filtration,” Biotechnol Bioeng 43:960-968 (1994)). Protein purification was further facilitated by the development of graphical optimization diagrams (van Reis et al., “Optimization Diagram for Membrane Separations,” J Membr Sci 129:19-29 (1997)). These are based on experimental protein sieving coefficients, which are assumed constant at their average values during an experiment.

Aggregate Transport Model. The above studies were, however, conducted with model binary solutions. Real suspensions encountered in wastewaters, auto-motive paint streams, and streams from the bioprocessing, food and beverage, and pharmaceutical industries are most often complex and polydisperse. Cell culture, fermentation broths, whole blood, and whole milk are representative examples of typical complex process streams. Baruah and Belfort (Baruah et al., “A Predictive Aggregate Transport Model for Microfiltration of Combined Macromolecular Solutions and Poly-Disperse Suspensions: Model Development,” Biotechnol Prog 19:1524-1532 (2003), and Baruah et al., “A Predictive Aggregate Transport Model for Microfiltration of Combined Macromolecular Solutions and Poly-Disperse Suspensions: Testing Model with Transgenic Goat Milk,” Biotechnol Prog 19:1533-1540 (2003)) presented the Aggregate Transport Model (ATM) for predicting MF and UF process performance for polydisperse suspensions. Prior to this work, only a few studies had been reported in the literature on modeling the behavior of polydisperse feeds containing both macro-molecules and suspended particles for microfiltration (Samuelsson et al., “Predicting Limiting Permeation Flux of Skim Milk in Cross-Flow Microfiltration,” J Membr Sci 129:277-281 (1997); Dharmappa et al., “A Comprehensive Model for Cross-Flow Filtration Incorporating Polydispersity of the Influent,” J Membr Sci 65:173-185 (1992)). Subsequently, Baruah and Belfort (Baruah et al., “Optimized Recovery of Monoclonal Antibodies from Transgenic Goat Milk by Microfiltration,” Biotechnol Bioeng 87:274-285 (2004)) combined the recommendations of the ATM with charge-based principles and uniform axial transmembrane pressure in the pressure-dependent regime, to obtain excellent yields (>95% in 4 diavolumes) of chimeric IgG from transgenic goat milk, a highly complex, polydisperse suspension. These results were facilitated by employing a shear enhanced helical hollow fiber membrane module, which utilized Dean vortices to reduce concentration polarization and fouling (U.S. Pat. RE 37,759 to Belfort). The ATM predicts solute transport through the deposit on the membrane but is restricted to the pressure-independent flux regime and uncharged solutes. This is the often popular regime of operation, where the permeation flux is at its highest value and does not increase with transmembrane pressure.

Thus, great strides have been made in MF/UF theory and practice in the past decade. However, to date there is no theory or model that can predict the performance of a general MF or UF process a priori because of difficulties in accounting for pH, ionic strength, sieving through the membrane cake, effect of hydrodynamics, variability of sieving coefficients, and other parameters during diafiltration and/or concentration, and membrane pore size distribution. A further complication is that, for a polydisperse case, each mass balance is governed by a differential equation and all of these differential equations are coupled. This has ruled out simple analytical solutions to the problem. One could use the full power of molecular dynamics (MD) to solve the MF/UF problem. However, with the current state of the art in computing technology and because of the complexity of the membrane process arising as a result of the large number of species and complex hydrodynamics, this would entail enormous expense and computation time. Hence MD is not a feasible option at present.

Theoretical Background. Traditional theories of MF and UF deal with mono-disperse suspensions and the pressure-independent regime (Belfort et al., “The Behavior of Suspensions and Macromolecular Solutions in Crossflow Microfiltration,” J Membr Sci 96:1-58 (1994)) where the dominant resistance is provided by the cake on the membrane wall. Both solvent and solute transport through the membrane are governed by the balance between convection of solutes to the membrane and the back-transport of solutes from the membrane wall to the bulk solution and solute sieving through the membrane wall (Belfort et al., “The Behavior of Suspensions and Macromolecular Solutions in Crossflow Microfiltration,” J Membr Sci 96:1-58 (1994); Zeman et al., “Microfiltration and Ultrafiltration Principles and Applications,” Chapter 5, Marcel Dekker: New York (1996)). For the fully retentive case, these back-transport mechanisms are given by (see Belfort et al., “The Behavior of Suspensions and Macromolecular Solutions in Crossflow Microfiltration,” J Membr Sci 96:1-58 (1994) for original sources):

$$\begin{matrix}J = 0.114 {( \frac{γ {k}^{′2} {T}^{2}}{{η}^{2} {a}^{2} L} )}^{1 / 3} ln ( \frac{{ϕ}_{w}}{{ϕ}_{b}} ) ( Brownian diffusion ) & ( 1 ) \\ J = 0.078 {( \frac{{a}^{4}}{L} )}^{1 / 3} γ ln ( \frac{{ϕ}_{w}}{{ϕ}_{b}} ) ( Shear \text{-} induced \text{diffusion} ) & ( 2 ) \\ J = \frac{0.036 ρ {a}^{3} {γ}^{2}}{η} ( Inertial lift ) & ( 3 )\end{matrix}$$

These equations do not predict solute transport; they ignore solute-solute and solute-wall interactions, and are valid only for the laminar flow regime.

As mentioned above, the ATM addresses two crucial aspects missing in the earlier theories: (i) a priori prediction of solute transport and (ii) solute polydispersity, which is prevalent in most real-world suspensions. The model was developed to predict the performance of microfiltration for polydisperse suspensions in terms of permeation flux and yield of a target species. The simplifying assumptions in ATM were: operation in the laminar flow regime, absence of interparticle and particle to membrane interactions and, as mentioned above, operation in the pressure-independent regime. The first step was to establish the particle size distribution of the suspension. Back-transport Eqs 1-3 were then employed to calculate the hypothetical monodisperse permeation fluxes for each particle size and concentration. The lowest of these permeation fluxes was then considered the rate-determining flux for the polydisperse suspension. This permeation flux was then used with the back-transport laws to calculate the composition of the deposited membrane cake, i.e., the concentration of each species (particles and colloids) in the filter cake. Essentially, this is the equilibrium concentration at the membrane wall that can ensure a balance between forward and back-transport of each species from the membrane. The evaluated packing densities of various particles are then tested with respect to packing constraints that limit the cake composition depending on the particle sizes. If the packing constraints are not satisfied, the highest packing density is lowered and the steps executed once again. This is repeated until all packing constraints are satisfied. Thus, the nature of the filter cake is evaluated and the interstitial gap between the particles is estimated. This is likened to a membrane pore and standard membrane theory based on steric exclusion, convective, and diffusional hindrance factors and hydrodynamics are used to estimate the yield of the target species (Zeman et al., “Microfiltration and Ultrafiltration Principles and Applications,” Chapter 5, Marcel Dekker: New York (1996)). If the yield of the target particle is between 0 and 95% for four diavolumes (observed sieving coefficient between 0 and 0.75), the nonretentive stagnant film model is employed for the target species and all steps are repeated to evaluate the corrected polydisperse permeation flux and yield. If the calculated yield is higher than 95% in 4 diavolumes further refinement is deemed unnecessary.

Zydney and Pujar have described the effect of colloidal interactions on solute transport through membranes (Pujar et al., “Electrostatic Effects on Protein Partitioning in Size-Exclusion Chromatography and Membrane Ultrafiltration,” J Chromatogr A 796:229-238 (1998)). They have concluded that the principles utilized in ion exchange and reversed phase chromatography could be gainfully employed for protein separations in membrane processes. Their focus is to evaluate solute transport rate given by

$$\begin{matrix}{N}_{s} = ϕ {K}_{c} {VC}_{w} \\ \text{Thus} , & ( 4 ) \\ ϕ = \frac{2}{{r}_{p}^{2}} {\int }_{0}^{{r}_{p}} exp ( \frac{- {ψ}_{total}}{{k}^{′} T} ) r ⅆ r \\ where & ( 5 ) \\ {ψ}_{total} = {ψ}_{HS} + {ψ}_{E} + {ψ}_{VDW} & ( 6 )\end{matrix}$$

and the subscripts HS, E, and VDW in Eq 6 represent the contribution to the total interaction potential by hard sphere repulsion, electrostatic interaction, and van der Waals forces, respectively. Furthermore,

$$\begin{matrix}{ψ}_{HS} = 0 for r = 0 to {r}_{p} - a and {ψ}_{HS} = ∞ for r = {r}_{p} - a to {r}_{p} & ( 7 ) \\ {ψ}_{E} = {A}_{1} {σ}_{s}^{2} + {A}_{2} {σ}_{p}^{2} + {A}_{3} {σ}_{s} {σ}_{p} \\ and & ( 8 ) \\ {ψ}_{VDW} = \frac{\frac{- π A}{3} {λ}^{3}}{{( 1 - {λ}^{2} )}^{3 / 2}} & ( 9 )\end{matrix}$$

Equation 7 is based on steric hindrance, i.e., on the usual definition of hard sphere repulsion that indicates no interaction while the colloids are separated and an infinite repulsion at contact. Equation 8 is based on the electrostatic interaction potential between a spherical colloid and a cylindrical pore calculated theoretically by Smith and Deen (Smith et al., “Electrostatic Double-Layer Interactions for Spherical Colloids in Cylindrical Pores,” J Coll Interface Sci 78:444-465 (1980)). Equation 9 is based on the work of Bhattacharjee and Sharma who have calculated the contribution of van der Waals interaction between a spherical colloid and a cylindrical pore (Bhattacharjee et al., “Lifshitz-van der Waals Energy of Spherical Particles in Cylindrical Pores,” J Colloid Interface Sci 171:288-296 (1995)). Hard sphere repulsion and electrostatics usually lead to positive contributions to the interaction potential and hinder solute transport through the membrane. The van der Waals component is usually negative and facilitates solute transport through the membrane. If conditions can be chosen such that the partition coefficient, ø, for two solutes is significantly different, good separation can be achieved. Practitioners of MF and UF processes have utilized steric exclusion and electrostatic repulsions to enhance separations. The van der Waals interaction is more subtle because, unlike chromatography, there is no elution step in membrane processes. Thus, an attractive interaction between the membrane pore and solute could lead to progressive deposits and fouling within the pores (pore narrowing). However, it may be possible to use van der Waals interactions along with electrostatics and steric factors to increase the difference in interaction potential with the pore for different solutes to obtain better separations.

Increasing wall shear rate and reducing membrane fouling through secondary or turbulent flows has been widely reported in the literature (Winzeler et al., “Enhanced Performance for Pressure-Driven Membrane Processes: The Argument for Fluid Instabilities,” J Membr Sci 80:35-47 (1993)). Dean vortices, which result from flow around a curved membrane duct, have been extensively studied and used to improve membrane performance (Luque et al., “A New, Coiled Hollow Fiber Module Design for Enhanced Microfiltration Performance,” Biotechnol Bioeng 65:247-257 (1999)). Transverse flow, resulting from conservation of angular momentum, induces additional wall shear over that obtained from axial flow. This is used to re-entrain particles from the membrane to the bulk fluid and hence reduce the buildup of deposits (fouling). This technology, in the form of flow in a helical membrane tube, is evaluated as part of the hydrodynamics component of the global model and optimization process in this work.

Despite all these advances, a global model to predict the performance of general MF and UF processes, a priori, does not exist because of the reasons highlighted above.

With increased pressure to commercialize therapeutics more quickly from more concentrated cell culture suspensions and fermentation broths, there is a great need for a global predictive model for pressure-independent and pressure dependent crossflow diafiltration utilizing MF and UF processes that is sufficiently rigorous to address all of the crucial parameters without being unduly computationally intensive.

The present invention is directed to overcoming these and other deficiencies in the art.

### SUMMARY OF THE INVENTION

The present invention relates to a method for determining optimum operating conditions for yield of a target species, purity of a target species, selectivity of a target species and/or processing time for crossflow membrane filtration of a polydisperse feed suspension having one or more target solute or particle species. This method involves providing as input parameters: size distribution of the particles and solutes in the suspension, concentration of particles and solutes in the suspension, suspension pH and temperature, membrane thickness, membrane hydraulic permeability (Lₚ), membrane pore size or molecular weight cut off, membrane module internal diameter, membrane module length, membrane area, membrane porosity, filtration system configuration, and reservoir volume (V). The method also involves determining effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each target solute or particle species through cake deposit and pores of the membrane using the provided input parameters. The method also involves solving a solute mass balance equation for each target species in each reservoir of the feed suspension based on the provided size distribution of the particles and solutes in the suspension; concentration of particles and solutes in the suspension; suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and the determined effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of a particle through cake deposit and pores of the membrane. The solute mass balance equation is iterated for each species at all possible permeation fluxes to determine purity, yield, selectivity, and/or processing time of crossflow filtration of the target species, thereby determining operating conditions that optimize for yield of a target species, selectivity of a target species, purity of a target species, and/or processing time and determining optimum operating conditions for crossflow membrane filtration of a polydisperse feed suspension having one or more target solute or particle species.

Another aspect of the present invention involves a computer readable medium which stores programmed instructions for predicting and optimizing operating conditions for yield of a target species, purity of a target species, selectivity of a target species and/or processing time for crossflow membrane filtration of a polydisperse feed suspension having one or more target species of solutes or particles. This medium includes machine executable code which, when provided as input parameters: size distribution of the particles and solutes in the suspension, concentration of particles and solutes in the suspension, suspension pH and temperature, membrane thickness, membrane hydraulic permeability (Lp), membrane pore size or molecular weight cut off, membrane module internal diameter, membrane module length, membrane area, membrane porosity, filtration system configuration, and reservoir volume (V); and executed by at least one processor, causes the processor to calculate the effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each target solute or particle species through cake deposit and pores of the membrane using the provided input parameters. The computer readable medium also causes the processor to solve the solute mass balance equation for each target solute or particle species in each reservoir of the feed suspension based on the provided size distribution of the particles and solutes in the suspension, concentration of particles and solutes in the suspension, suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and the calculated effective membrane pore size distribution (λ′), viscosity of the suspension, hydrodynamics of the suspension, electrostatics of the suspension, pressure-independent permeation flux (JPD) of the suspension and cake composition, pressure-independent permeation flux [J_{PI}(i)] for each particle (i) in the suspension, and overall observed sieving coefficient of a particle through cake deposit and pores of the membrane. The computer readable medium also causes the processor to iterate the solute mass balance equation for each species at all possible permeation fluxes to determine time, yield, selectivity, and processing time of crossflow filtration. The computer readable medium of present invention also causes the processor to analyze the results of the mass balance equations and predict the operating conditions that optimize for yield of a target species, selectivity of a target species, purity of a target species, and/or processing time, thereby predicting and optimizing operating conditions of crossflow membrane filtration of a polydisperse feed suspension containing one or more target solute or particle species.

The present invention also relates to an algorithm structure encompassing the global model of the present invention.

The algorithm and the computer model of the present invention based upon the algorithm, are validated for a wide variety of applications, and are used to fill the gaps in current MF/UF theory, making realistic and rapid in silico MF/UF optimizations with various membranes and operating conditions possible.

The present invention provides a broadly applicable global model and corresponding algorithms that predict the performance of crossflow MF and UF processes, in combination or individually, in the laminar flow regime in both pressure-dependent and pressure-independent regimes. This model optimizes complex MF/UF processes rapidly in terms of yield of target species, purity, selectivity of solute particle, or processing time. Computer programs, based on the model algorithm, allow one to conduct various in silico experiments to mimic typical MF/UF scenarios. These simulations are used to investigate the effects of pH, ionic strength, membrane pore size, membrane wall shear rate, and permeation flux on MF/UF performance parameters such as selectivity of one solute over the other, diafiltration time, yield, and purity. Based on the in silico results, operating conditions are selected to achieve the optimum outcome when applied to a real-world filtration process. The validation studies described in the Examples, herein below, demonstrate that the model has a high correlation to empirical MF/UF experiments conducted by different researchers.

### BRIEF DESCRIPTION OF THE DRAWINGS

FIG. 1 is a flowchart of the algorithm used in the global MF/UF model of the present invention

FIG. 2 is a flow diagram of an exemplary dual microfiltration/ultrafiltration (MF/UF) system of the present invention suitable for carrying out the method of the present invention, showing three internal recycle loops.

FIG. 3 shows the jth reservoir of a generalized system containing n reservoirs and n membranes.

FIG. 4 is a graph comparing selectivity (ratio of sieving coefficients) between Hb and BSA as a function of ionic strength for a batch ultrafiltration experiment carried out by Raymond et al., “Protein Fractionation Using Electrostatic Interactions in Membrane Filtration,” Biotechnol Bioeng 48:406-414 (1995) (Raymond), which is hereby incorporated by reference in its entirety) at pH 6.8 with a 100 kDa membrane (♦=experimental data points) and optimum selectivity (solid curve) determined using a computer simulation of based on the global model of the present invention using Raymond's experimental data. R²=0.99.

FIG. 5 is a graph showing the yield of Hb during diafiltration of a 6 g/L BSA and 4 g/L Hb solution at pH 7.1, permeation flux of 9 Lmh, and I=3.2 mM for batch ultrafiltration experiment (Raymond et al., “Protein Fractionation Using Electrostatic Interactions in Membrane Filtration,” Biotechnol Bioeng 48:406-414 (1995), which is hereby incorporated by reference in its entirety) (♦=experimental data points). The solid curve is the result of computer simulations based on the global model. R²=0.99.

FIG. 6 is a graph showing diafiltration time as a function of the transgenic goat milk concentration factor at pH=9.0 for yields of 95% IgG in the permeate stream based on experiments of Baruah et al., “Optimized Recovery of Monoclonal Antibodies from Transgenic Goat Milk by Microfiltration,” Biotechnol Bioeng 87:274-285 (2004), which is hereby incorporated by reference in its entirety. The microfiltration module was a 6-fiber helical hollow fiber module of length 135 mm, filtration area of 32 cm², and average pore diameter of 100 nm at 298 K. The solid curve is the result of computer simulations based on the global model. R²=0.99 without outrider at a milk concentration factor of 1.5.

FIG. 7 is a graph showing the global model of the present invention used to calculate an effective radius of a BSA molecule at pH 6.8 and various ionic strengths with divalent ions (solid line).

FIGS. 8A-B are graphs showing a model-simulated optimum selectivity (ratio of sieving coefficients) for diafiltration of a feed suspension including Hb and BSA. FIG. 8A shows the selectivity between Hb and human serum albumin (HSA) as a function of pH in the range 6.5-9.0. FIG. 8B shows the selectivity between HSA and Hb as a function of pH in the range 5-6 for batch in silico ultrafiltration experiments with a 100 kDa membrane at an ionic strength of 2 mM and divalent ions.

FIGS. 9A-B are graphs showing model simulated optimums for diafiltration of a feed suspension of Hb and BSA. FIG. 9A shows sieving coefficients of Hb (filled columns) and BSA (empty columns) using different molecular weight cut off (MWCO) UF membranes. FIG. 9B shows selectivity between Hb and BSA as a function of MWCO for batch in silico ultrafiltration experiments at an ionic strength of 1.8 mM and divalent ions.

FIGS. 10A-B are graphs showing model simulated optimums for diafiltration of a feed suspension of Hb and BSA at different permeation rates. FIG. 10A is modeled sieving coefficients of Hb (solid line) and BSA (dashed line). FIG. 10B shows the selectivity between Hb and BSA as a function of permeation flux for batch in silico ultrafiltration experiments with a 100 kDa membrane at an ionic strength of 1.8 mM and divalent ions.

FIG. 11 is a graph showing diafiltration time as a function of the wall shear rate during microfiltration of transgenic goat milk at pH=9.0 for yields of 95% IgG in the permeate stream, which were the result of computer simulations based on the global model. The filtration module was a 6-fiber helical hollow fiber membrane module with a length of 135 mm, filtration area of 32 cm², and pore diameter of 100 nm at 298 K.

FIGS. 12A-B are graphs showing model simulated optimums for batch in silico ultrafiltration experiments. FIG. 12A shows selectivity between a neutral Hb and an Hb+ mutant with a single positive charge as a function of ionic strength for batch in silico ultrafiltration experiments. FIG. 12B shows yield (solid line) and purity (dashed line) of Hb in the diafiltration of a 1 g/L Hb and 0.2 g/L Hb+mutant solution at pH 6.8 and I=1 mM NaCl in the permeate stream for a diafiltration in silico ultrafiltration experiments with a 100 kDa membrane.

FIG. 13 is a graph showing model simulated diafiltration time as a function of the transgenic goat milk concentration factor for a helical (solid curve) and a linear (dashed curve) 6-fiber helical hollow fiber module of length 135 mm, filtration area of 32 cm² and average pore diameter of 100 nm at 298 K, pH=9.0 for yields of 95% IgG in the permeate stream.

### DETAILED DESCRIPTION

The present invention relates to a method for determining optimum operating conditions for yield of a target species, purity of a target species, selectivity of a target species and/or processing time for crossflow membrane filtration of a polydisperse feed suspension having one or more target solute or particle species. This method involves providing as input parameters: size distribution of the particles and solutes in the suspension, concentration of particles and solutes in the suspension, suspension pH and temperature, membrane thickness, membrane hydraulic permeability (Lₚ), membrane pore size or molecular weight cut off, membrane module internal diameter, membrane module length, membrane area, membrane porosity, filtration system configuration, and reservoir volume (V). The method also involves determining effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each particle target species through cake deposit and pores of the membrane using the provided input parameters. The method also involves solving a solute mass balance equation for each target species in each reservoir of the feed suspension based on the provided size distribution of the particles and solutes in the suspension, concentration of particles and solutes in the suspension, suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and the determined effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of a particle through cake deposit and pores of the membrane. The solute mass balance equation is iterated for each species at all possible permeation fluxes to determine purity, yield, selectivity, and/or processing time of crossflow filtration of the target species, thereby determining operating conditions that optimize for yield of a target species, selectivity of a target species, purity of a target species, and/or processing time for crossflow membrane filtration of a polydisperse feed suspension having one or more target species of solutes or particles

The “target species” of the present invention may be a solute or a particle present in the polydisperse feed suspension, therefore, “solute” and “particle” are used interchangeably throughout in describing the present invention. As used herein, the distinction between a solute and a particle is based on size. A solute is meant to include any molecule or ion present in the feed suspension that is ≦0.1 μm in diameter. A particle as used herein is meant to include aggregates of solutes, where the particle has a diameter of >0.1 μm. One of skill in the art of crossflow filtration would understand that the size distinction between solutes and particles is applicable to the selection of membrane type for the filtration system. In crossflow filtration systems, ultrafiltration is generally directed to recovery of target solute species, while microfiltration is carried out for the recovery of target particle species. Selection of an appropriate membrane for a given crossflow filtration system, based on a suitable molecular weight cutoff (MWCO) for ultrafiltration, or suitable pore size for microfiltration (μm), is dependent on the desired target species.

The present invention also relates to an algorithm structure encompassing the global model of the present invention. The term “algorithm” as used herein refers to any of a variety of programming methodologies utilizing a combination of modules of the global model of the present invention to conduct in silico simulations and optimizations of MF/UF processes. In the present invention, the variables are represented by various notations and Greek letters, commonly used on the art. Table 1, below, provides the meaning of the notations and Greek letters as used herein.

TABLE 1
Notation

| | |
|---|---|
| A | effective Hamaker interaction constant between a solute |
| | and pore (J) |
| a | radius of species (m) |
| Cᵢ | concentration of ions (mol/m³) |
| C_{w} | concentration at the wall (kg/m³) |
| D | molecular diffusion coefficient (m²/ₛ) |
| d | internal diameter of membrane module bore (mm) |
| F | repulsion force between charged colloids (N) |
| Fa | Faraday constant (C/mol) |
| f | friction coefficient (−) |
| h | separation distance between charged colloids (nm) |
| I | ionic strength (mM) |
| J | solvent permeation flux (m/s) |
| k | mass transfer coefficient (m/s) |
| k′ | Boltzmann constant (J/mol K) |
| kₗ | shape factor (−) |
| K_{c} | hindrance factor for convective transport (−) |
| K_{d} | hindrance factor for diffusive transport (−) |
| L | membrane tube length (m) |
| Lₚ | hydraulic permeability of the membrane (m/s-Pa) |
| N_{d} | number of diavolumes during diafiltration (−) |
| Nₛ | solute permeation flux (kg/m²-s) |
| Peₘ | membrane Peclet number (−) |
| R | gas constant (J/mol-K) |
| rₚ | pore radius (nm) |
| Re | Reynolds number (−) |
| s | specific pore area (m) |
| Sₒ | observed sieving coefficient (−) |
| S_{oaverage} | average observed sieving coefficient during |
| | diafiltration (−) |
| Sₐ | actual sieving coefficient (−) |
| S_{∝} | asymptotic (intrinsic) sieving coefficient (−) |
| Sₒₘₑₘ | observed sieving coefficient for particle i through |
| | a membrane |
| t | time (s) |
| T | temperature (K) |
| uᵢ | back diffusion velocity of particle i (m/s) |
| V | filtration velocity (m/s) |
| Vₐₓᵢₐₗ | axial velocity in membrane bore (m/s) |
| Z | valency of ions |

Greek letters

| | |
|---|---|
| δ | momentum boundary layer thickness (m) |
| δₘ | membrane/cake thickness (m) |
| ε | permittivity of solvent (C²/J-m) |
| εₗ | cake/membrane porosity (−) |
| ø | equilibrium partition coefficient between membrane |
| | pore and solution (−) |
| ø_{b} | the particle volume fraction in the bulk solution (−) |
| øₘ | maximum packing volume fraction for monodisperse |
| | spheres (−) |
| ø_{M} | maximum aggregate packing volume fraction for all |
| | particles (−) |
| ø_{w} | the particle volume fraction at the membrane wall (−) |
| κ⁻¹ | Debye length (nm) |
| γ | wall shear rate (s⁻¹) |
| η | bulk fluid viscosity (kg/m · s) |
| η₀ | bulk fluid viscosity without solute (kg/m · s) |
| λ | ratio of solute to pore radii (a/rₚ) (−) |
| λ′ | statistical equilibrium partition coefficient (−) |
| σ | surface charge (C/m²) |
| ρ | particle density (kg/m³) |
| ψ | interaction energy (J) |

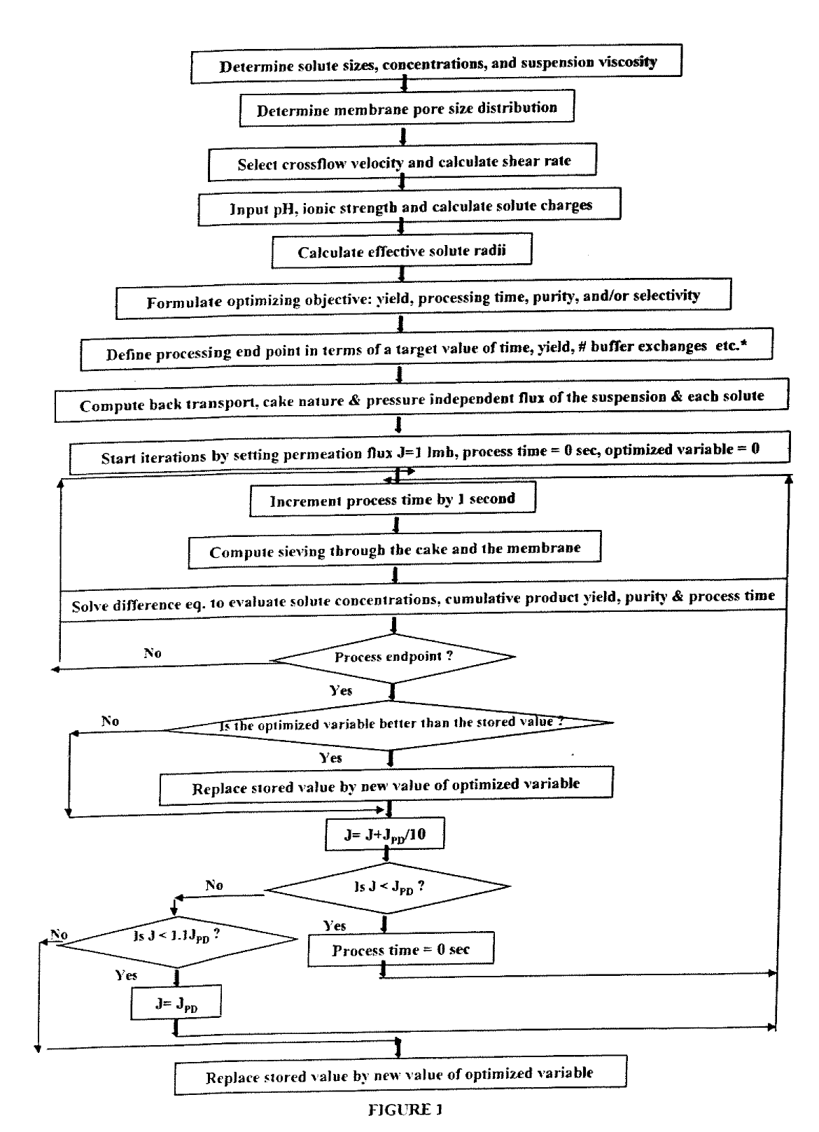

Most parameters crucial to MF/UF performance are considered in the global model of the present invention. These aspects can be considered as various modules (or components) of the global MF/UF model, as shown in FIG. 1. The assumptions for the global model of the present invention are 100% sieving for salts, laminar flow, no counter osmotic flow, and no adhesion to the membrane. Also, the charge on the membrane is assumed to be negligible. The calculations to account for all these factors are necessarily complex and iterative. The present invention, therefore, also relates to written computer programs to suit the model algorithm adapted for different MF/UF scenarios. Although in the algorithm there are many cross connections between the modules, for the sake of clarity the modules are described individually herein, as follows.

1. Suspension Details. The particle size distribution of the feed suspension is determined and the equivalent spherical radii of each particle type are evaluated. This can be obtained from literature, by size exclusion chromatography, and/or by membrane fractionation or light scattering experiments. For globular proteins, the radii are taken equal to the Stokes radii based on literature data (Torre et al., “Calculation of Hydrodynamic Properties of Globular Proteins from their Atomic Level Structure,” Biophys J 78:719-730 (2000); Dupont et al., “Translational Diffusion of Globular Proteins in the Cytoplasm of Cultured Muscle Cells,” Biophys J 78:901-907 (2000); Zydney et al., “Permeability and Selectivity Analysis for Ultrafiltration Membranes,” J Membr Sci 249:245-249 (2005); Negin et al., “Measurement of Electrostatic Interactions in Protein Folding with the Use of Protein Charge Ladders,” J Am Chem Soc 124:2911-2916 (2001), which are hereby incorporated by reference in their entirety). Briefly, Stokes radii (Rₛ) (nm), are calculated from the binary diffusion coefficients D, measured in a liquid of viscosity η at temperature T, using the Stokes-Einstein relation (Zeman et al., “Microfiltration and Ultrafiltration Principles and Applications,” Chapter 1, pg. 13; Marcel Dekker: New York (1996), which is hereby incorporated by reference in its entirety). Solutes present in trace quantities may be neglected based on criteria indicated herein below (see Step 5 of module 5). The viscosity of the suspension is evaluated by experiment or estimated by using the modified Einstein-Smoluchowski equation (Belfort et al., “The Behavior of Suspensions and Macromolecular Solutions in Crossflow Microfiltration,” J Membr Sci 96:1-58 (1994), which is hereby incorporated by reference in its entirety):

$$\frac{η}{{η}_{0}} = 1 + 2.5 {ϕ}_{b} + {k}_{1} {ϕ}_{b}^{2} \qquad ( 10 )$$

where φ is <0.40 and k1 has a value of ˜10 for spheres.
The concentrations of the various solutes and particles present in the feed suspension are also provided as input parameters to the model.

2. Membrane Properties. Membrane properties such as thickness, porosity, and hydraulic permeability are obtained from the manufacturer for existing membranes or estimated on the basis of literature values for in silico simulations. The nominal pore radius is taken from manufacturer's data for MF and estimated as that of a hypothetical globular protein having a molecular weight equal to the molecular weight cutoff value for UF membranes. The effect of membrane pore size distribution is estimated using the statistical equilibrium partition coefficient λ′, based on Giddings et al., “Statistical Theory for the Equilibrium Distribution of Rigid Molecules in Inert Porous Networks,” J Phys Chem 72:4397-4408 (1968) (which is hereby incorporated by reference in its entirety), instead of the traditional solute to pore radius ratio λ, for computing solute transport. This is expressed as

$$\begin{matrix}{λ}^{′} = 1 - exp ( \frac{- a}{2 s} ) \\ where & ( 11 ) \\ s = {( \frac{5 {ηδ}_{m} {L}_{p}}{{ɛ}_{1}} )}^{1 / 2} & ( 12 )\end{matrix}$$

Equation 11 indicates that, unlike λ, λ′ is always less than 1, even for very large solutes. This ensures that there will be some leakage of large solutes through the membrane, as observed practically. Equations 11 and 12 have been successfully used to model protein transport in both symmetric and asymmetric membranes (Opong et al., “Diffusive and Convective Transport Through Asymmetric Membranes,” AIChE J 37:1497-1510 (1991); Mochizuki et al., “Dextran Transport Through Asymmetric Ultrafiltration Membranes: Comparison with Hydrodynamic Models, J Membr Sci 68:21-41 (1992); Langsdorf et al., “Diffusive and Convective Transport Through Hemodialysis Membranes: Comparison with Hydrodynamic Predictions,” J Biomed Mater Res 28:573-582 (1994), which are hereby incorporated by reference in their entirety).

3. Hydrodynamics. The membrane itself is only one component of a complete membrane system. The functional UF or MF crossflow filtration system includes requisite pumps and feed vessels; piping, tubing, and associated connections; monitors and control units for pressure, temperature, and flow rate, and most importantly, the membrane module (Zeman et al., “Microfiltration and Ultrafiltration Principles and Applications,” p. 327, Marcel Dekker: New York (1996), which is hereby incorporated by reference in its entirety). The membrane module, as used herein, refers to the physical unit that houses the UF or MF membranes in an appropriately designed filter system configuration. Module channel diameter, length, surface area, and type are input parameters used to evaluate the hydrodynamic parameters of the filtration process. The axial velocity (Vₐₓᵢₐₗ) of the MF/UF process can either be fixed (as demonstrated in the Examples, below) or can be back-calculated from a specified Reynold's number (Re). Using Eq 10 for the bulk suspension viscosity, axial velocity is calculated from Re as follows:

$$\begin{matrix}Re = \frac{ρ d {V}_{axial}}{{η}_{0} ( 1 + 2.5 {ϕ}_{b} + {k}_{1} {ϕ}_{b}^{2} )} \\ where & ( 13 ) \\ {V}_{axial} = \frac{Re {η}_{0} ( 1 + 2.5 {ϕ}_{b} + {k}_{1} {ϕ}_{b}^{2} )}{ρ d} & ( 14 )\end{matrix}$$

and wall shear rate (based on bulk suspension viscosity),

$$γ = ( \frac{d}{4 η} ) ( \frac{Δ P}{L} ) \qquad ( 15 )$$

Volume fractions in Eq 14 are evaluated by dividing solute concentration by solute density. Using the relations ΔP=(4fL/d)ρ(V²ₐₓᵢₐₗ)/2 for pressure drop in a tube and f=16/Re, valid for the laminar regime, Eq 15 transforms wall shear rate (γ) to the simple relation

$$γ = \frac{8 {V}_{axial}}{d} \qquad ( 16 )$$

for a linear membrane module. For shear-enhanced helical membrane modules, this value (γ) is multiplied by 1.95, to estimate the higher value of wall shear rate, based on experimental observations (Al-Akoum et al., “Hydrodynamic Characterization and Comparison of Three Particular Systems Used for Flux Enhancement: Application to Crossflow Filtration of a Yeast Suspension,” ICOM 573 (2002), which is hereby incorporated by reference in its entirety).

Additional values provided as input parameters in the present invention involve the details of the filtration system configuration, which includes the number of reservoirs in the system, the number of membranes in the system, and the connectivity of the filters and reservoirs, including pumps.

4. Electrostatics. At the solution pH, the solute charges have to be evaluated. The procedure adopted to estimate the net protein charge based on the solution is standard in biochemistry and will be discussed only briefly here. In the case of proteins, this is estimated by computing the charges of the ionizable residues and the terminal groups based on the pKₐ values of the residues and the Henderson-Hasselbach (H-H) equation (J Chem Educ 78:1499-1503 (2001), which is hereby incorporated by reference in its entirety) or computer programs available to estimate the charge on a protein of known structure and sequence and in known solution conditions (e.g., DelPhi Poisson-Boltzmann Electrostatics Simulation Engine; Accelrys: San Diego, Calif., which is hereby incorporated by reference in its entirety). The ionizable residues are assumed to be exposed at the protein surface, as a result of the polar environment of aqueous solutions. The details of the ionizable amino acids are based on Voet et al., “Fundamentals of Biochemistry,” Wiley: New York (1999), (which is hereby incorporated by reference in its entirety). Thus,
pH=pKₐ+log [A]/[HA] (17)
where A is the basic form and HA is the acidic form. If the residue is an acid, its charge is negative at pH>pKₐ because of deprotonation (basic form) and neutral otherwise. For a basic residue the charge is positive if pH<pKₐ because of protonation (acidic form) and neutral otherwise. This is illustrated for lysine, which is a base and has a pKₐ of 10.52, for a solution pH of 9.5 by using the H-H equation:
[A]/[HA]=0.0955
The fraction in the acidic form is [HA]/([A]+[HA])=0.91. Hence the net charge of lysine at pH 9.5 is +0.91×1+0.09×0=+0.91. The overall protein charge is estimated by adding up all the charges for the residues and the terminal groups. As would be understood by one of skill in the art, the pI (i.e., isoelectric point) of a protein is the pH at which the protein has no net charge. Thus, the pI can also be determined using the H-H equation.

In reality, of course, the charges on a protein surface are not uniformly of one sign (Yoon et al., “Computation of the Electrostatic Interaction Energy Between a Protein and a Charged Surface,” J Phys Chem 96:3130-3134 (1992), which is hereby incorporated by reference in its entirety). The above approximations have been made to keep the problem tractable. The effect of electrostatics on filtration is estimated by evaluating an effective radius of a colloid due to its double layer. Because a charged molecule seems larger due to its charge, using the effective radius of the colloid rather than the actual radius takes into account the drag on a molecule due to its charge. This accounts for interactions between the charged colloid and the membrane pore/cake interstice. As shown subsequently, these interactions can give reasonable estimates for the sieving through both the deposit and the membrane pores. Equation 8, obtained by Smith and Deen (Smith et al., “Electrostatic Double-Layer Interactions for Spherical Colloids in Cylindrical Pores,” J Coll Interface Sci 78:444-465 (1980), which is hereby incorporated by reference in its entirety), was used for further analysis by Pujar and Zydney (Pujar et al., “Electrostatic Effects on Protein Partitioning in Size-Exclusion Chromatography and Membrane Ultrafiltration,” J Chromatogr A 796:229-238 (1998), which is hereby incorporated by reference in its entirety). A₁, A₂, and A₃ are positive coefficients and functions of the solution ionic strength, pore radius, and the solute radius, while σₛ and σₚ are the surface charge densities of the solute and pore, respectively. The first term in Eq 8 deals with the distortion of the double layer around the solute due to the pore, the second term with the distortion of the double layer around the pore due to entrance of the solute, and the third term with actual pore solute interactions. It is reasonable to consider only A₁ as nonzero, under conditions where the surface charge density of the solute is much larger than that of the membrane pore as assumed for the global model. The energy of interaction at the pore centerline was evaluated along with suitable assumptions of low ionic strength (hence small κ) and narrow pores (small rₚ) (Pujar et al., “Electrostatic Effects on Protein Partitioning in Size-Exclusion Chromatography and Membrane Ultrafiltration,” J Chromatogr A 796:229-238 (1998), which is hereby incorporated by reference in its entirety) to give

$$\frac{{ψ}_{E}}{{k}^{′} T} = \frac{8 {λ}^{′2} {a}^{2} {σ}_{s}^{2}}{{κɛɛ}_{0} {k}^{′} T} \qquad ( 18 )$$

The effective solute radius is then given by

$${a}_{effective} = a + ( \frac{4 {a}^{3} {σ}_{s}^{2}}{{ɛɛ}_{0} {k}^{′} T} ) {λ}^{′} ( 1 - {λ}^{′} ) {κ}^{- 1} \qquad ( 19 )$$

where λ′ is as defined in Eq 11 and the Debye length, κ⁻¹, is given as

$${κ}^{- 1} = {( \frac{ɛ RT}{F {a}^{2} \sum {Z}_{i}^{2} {C}_{i}} )}^{1 / 2} \qquad ( 20 )$$

(Zeman et al., “Microfiltration and Ultrafiltration Principles and Applications,” Marcel Dekker: New York (1996), which is hereby incorporated by reference in its entirety). The surface charge density of the colloid is given by

$${σ}_{s} = no . of charges \times \frac{e}{4 π {a}^{2}} ( assuming spherical colloid ) \qquad ( 21 )$$

Equation 19 incorporates both the effect of the Debye length (κ⁻¹) and the distribution of the charge on the surface (by use of the surface charge density, σₛ) and the solute to pore radius. However, a_{effective} is a weak function of the pore radius (rₚ) for a fairly broad range of pore sizes with an average value of 0.2 for the λ′(1−λ′) term. This effective solute radius (a_{effective}) thus evaluated is used instead of a in all further calculations in the global model.

5. Cake Composition and Pressure-Independent Flux. The next step involves determining the limiting pressure-independent flux for the polydisperse suspension and the cake composition using an adaptation of the ATM (Baruah et al., “A Predictive Aggregate Transport Model for Microfiltration of Combined Macromolecular Solutions and Poly-Disperse Suspensions: Model Development,” Biotechnol Prog 19:1524-1532 (2003); Baruah et al., “A Predictive Aggregate Transport Model for Microfiltration of Combined Macromolecular Solutions and Poly-Disperse Suspensions: Testing Model with Transgenic Goat Milk,” Biotechnol Prog 19:1533-1540 (2003), which are hereby incorporated by reference in their entirety). The hypothetical pressure-independent flux for each solute is then determined. This is equivalent to the pressure-independent flux for the polydisperse suspension for fully retained particles and equivalent to the hypothetical suspension flux corresponding to the maximum possible packing of a transmitted solute ignoring other transmitted solutes. In effect, for each transmitted solute, only the retained particles in addition to the solute itself are considered. This leads to a situation where the cake on the membrane consists of the retained particles and the solute particles are squeezed into the interstices. The permeation flux corresponding to this is calculated here. This is used later to estimate sieving through the deposit. The steps of this calculation are as follows.

Step 1. Evaluate the pressure-independent flux for a monodisperse suspension Jₘᵢ, for a particle “i” based on Brownian diffusion (BD) and shear-induced diffusion (SID) at the proposed operating wall shear rate and bulk concentration, assuming full retention for all solutes, i.e.:

$${J}_{m i} = Max [ BD ln ( \frac{{ϕ}_{w}}{{ϕ}_{b}} ) , SID ln ( \frac{{ϕ}_{w}}{{ϕ}_{b}} ) ] \qquad ( 22 )$$

where BD=0.114(γk′²T²/η²a²L)^{1/3} and SID=0.078(a⁴/L)^{1/3}γ denote the functionalities for Brownian diffusion and shear-induced diffusion, respectively, based on Eqs 1 and 2. φ_{w}=0.64 is set for each species for the first iteration (Dodds, J., “The Porosity and Contact Points in Multicomponent Random Sphere Packings Calculated by a Simple Statistical Geometric Model,” J Colloid Interface Sci 77:317-327 (1980), which is hereby incorporated by reference in its entirety).

Step 2. Estimate the maximum aggregate packing volume fraction for all particles, φ_{M}, at the wall from geometric considerations. For the polydisperse case, this could be much larger than the widely used value 0.64 depending on the size ratios of the particles. If the size ratio is more than 10, the small particles are assumed to behave as a continuous fluid with respect to the large particles and can easily migrate into the interstices (Farris, R., “Prediction of the Viscosity of Multimodal Suspensions from Unimodal Viscosity Data,” Trans Soc Rheol 12:281-301 (1968); Probstein et al., “Bimodal Model of Concentrated Suspension Viscosity for Distributed Particle Sizes,” J Rheol 38:811-829 (1994); Gondret et al., “Dynamic Viscosity of Macroscopic Suspensions of Bimodal Sized Solid Spheres,” J Rheol 41:1261-1274 (1997), which are hereby incorporated by reference in their entirety). For example, for a polydisperse mixture comprising particles of three sizes such that α1>10α2>100α3 the following relation may be used:
φ_{M}=φₘ+φₘ(1−φₘ)+0.74[1−{φₘ+φₘ(1−φₘ)}] (23)
where φₘ is the maximum packing volume fraction for monodisperse spheres, 0.64 (Dodds, J., “The Porosity and Contact Points in Multicomponent Random Sphere Packings Calculated by a Simple Statistical Geometric Model,” J Colloid Interface Sci 77:317-327 (1980), which is hereby incorporated by reference in its entirety).

In this special case, φₘ=0.96. The choice of 0.74 for the packing of the smallest particles is based on face-centered cubic packing, which gives the highest packing density geometrically.

Step 3. Iterate for all particle sizes and select the particle that gives the minimum permeation flux at the given wall shear rate. This is the limiting value, hence, the pressure-independent polydisperse permeation flux of the suspensions is:
J_{PD}=Min[Jₘ₁,Jₘ₂, . . . , Jₘₙ] (24)
where the selected particle has a radius aₘ.

Step 4. Evaluate packing density for other particle sizes (aᵢ for i≠m) at this permeation flux. Calculate φᵢ from the equation

$${ϕ}_{wi} = Min [ {ϕ}_{bi} exp ( \frac{{J}_{PD}}{BD} ) , {ϕ}_{bi} exp ( \frac{{J}_{PD}}{SID} ) ] \qquad ( 25 )$$

for all i≠m.

Step 5. Check Σφ_{wi}≦φ_{M} and other packing constraints. These depend on the particle sizes in the cake and have to be developed specifically for each case. Packing constraints of the cake formed at the membrane wall depend on the size distribution of the particles in the bulk suspension. A few aspects have been covered in module 5 of the global model for MF and UF described earlier. Guidelines to develop packing constraints for a general case are given as follows:

First, estimate the maximum aggregate packing volume fraction for all particles. Variants of Eq 23 may be used. If the maximum radius ratio of the particles is <10, φ_{M} can be set to 0.68 based on the literature (Gondret et al., “Dynamic Viscosity of Macroscopic Suspensions of Bimodal Sized Solid Spheres,” J Rheol 41:1261-1274 (1997), which is hereby incorporated by reference in its entirety). If there are two distinct groups of particles separated by a factor of ≧10 in radii, a truncated version of Eq 23 may be used:
φ_{M}=φₘ+0.74(1−φₘ) (41)
where φₘ may be set to 0.64 to denote the highest packing volume fraction for a single species. In a manner similar to Eqs 23 and 41, φ_{M} for the case for more than three distinct particle size groups can be estimated. The particle composition of the cake and the bulk suspension will be different because of the different back-transport mechanisms applicable for different particle types. It is possible that certain particles get swept away from the wall at very high back-transport rates. These particles can be eliminated from the cake if their back-transport rates are more than 10 times higher than the polydisperse flux evaluated in step 3 of module 5. This will simplify the problem.

If packing constraints are satisfied, go to the next step (i.e., Step 6 of module 5) or else correct by using

$${ϕ}_{wicorrected} = {ϕ}_{M} ( \frac{{ϕ}_{wi}}{\sum {ϕ}_{wi}} ) \qquad ( 26 )$$

For the particle selected in Step 3 of module 5, reevaluate the final estimate of the pressure-independent polydisperse permeation flux of the suspension, J_{PD} based on φ_{wicorrected} instead of 0.64 by repeating Steps 1 and 3. Thus, the cake composition and the polydisperse suspension permeation flux at pressure-independent conditions are determined.

Step 6. Next, the hypothetical pressure-independent flux, J_{PI}(i) corresponding to each particle is estimated. The deposit is considered to consist only of the nominally retained particles at packing densities corresponding to the pressure-independent flux of the polydisperse suspension and the particle in question. All other particles are ignored. The particle is assumed to be packed within the deposit at its maximum allowable packing density from packing considerations enumerated earlier. For nominally retained particles, J_{PI}=J_{PD} and for transmitted particles J_{PI}≧J_{PD}. For example, if the particle i is less than 10 times in radius than the smallest retained particle, then

$$\begin{matrix}{ϕ}_{wi} = 0.74 ( 1 - \sum {ϕ}_{wretained} ) \\ and & ( 27 ) \\ {J}_{PI} ( i ) = Max [ BD ln ( \frac{{ϕ}_{wi}}{{ϕ}_{bi}} ) , SID ln ( \frac{{ϕ}_{wi}}{{ϕ}_{bi}} ) ] & ( 28 )\end{matrix}$$

6. Sieving Coefficients through the Deposit and Membrane. The ATM of Baruah and Belfort described the method of calculating solute transport through the deposit at the pressure-independent permeation flux of the polydisperse suspension, based on the geometry of the deposit at this condition (Baruah et al., “A Predictive Aggregate Transport Model for Microfiltration of Combined Macromolecular Solutions and Poly-Disperse Suspensions: Model Development,” Biotechnol Prog 19:1524-1532 (2003), WO 2004/016334 to Belfort et al., which are hereby incorporated by reference in their entirety). This composition is defined by packing constraints, suspension conditions, electrostatics, and hydrodynamics of the process. It is, however, not possible to ascertain the deposit composition at lower permeation fluxes in the pressure-dependent regime. It was experimentally observed, in studies with milk microfiltration, that there is an approximately inverse relationship between the sieving coefficient through the deposit and the ratio of actual flux (J_{actual}) to the pressure independent flux for the particle in question. (Baruah et al., “Optimized Recovery of Monoclonal Antibodies from Transgenic Goat Milk by Microfiltration,” Biotechnol Bioeng 87:274-285 (2004), which is hereby incorporated by reference in its entirety). Thus for particle i,

$${S}_{odeposit} ( i ) = 1 - \frac{{J}_{actual}}{{J}_{PI} ( i )} \qquad ( 29 )$$

Equation 29 implies that sieving through the deposit for a particle is 0% when the particle is packed at the highest density and is 100% at 0 permeation flux corresponding to no deposit. This relationship is reasonable and is supported qualitatively by Forman et al., who showed that a protein exhibited a sieving coefficient higher than 90% at a very low permeation flux of 3 Lmh (Forman, et al., “Cross-Flow Filtration of Inclusion Bodies from Soluble Proteins in Recombinant E-Coli Cell Lysate,” J Membr Sci 48:263-279 (1990), which is hereby incorporated by reference in its entirety). This is also corroborated by the work of Bailey and Meagher (Bailey et al., “Cross-Flow Microfiltration of Recombinant E-Coli Cell Lysates After High-Pressure Homogenization,” Biotechnol Bioeng 56:304-310 (1997), which is hereby incorporated by reference in its entirety). The sieving coefficient through the membrane pores is evaluated by the traditional method based on solute partitioning coefficient, solvent transport parameters, and membrane characteristics as described elsewhere (Zeman et al., “Microfiltration and Ultrafiltration Principles and Applications,” Chapter 5, Marcel Dekker: New York (1996), which is hereby incorporated by reference in its entirety). However, the calculations are performed with effective solute to pore size ratio λ′ instead of λ and a_{effective} instead of a. This accounts for pore size variation of the membrane evaluated from its hydraulic permeability and the electrostatics of the process. The intrinsic sieving coefficient S_{∞} is obtained from
S_{∞}=(1−λ′)²[2−(1−λ′)²]exp(−0.7146λ²) (30)

The wall Peclet number, Peₘ is obtained from

$$\begin{matrix}P {e}_{m} = ( \frac{{J}_{actual} {δ}_{m}}{D} ) ( \frac{{S}_{∞}}{∈ ϕ {K}_{d}} ) \\ where & ( 31 ) \\ ϕ {K}_{d} = {( 1 - {λ}^{′} )}^{9 / 2} & ( 32 )\end{matrix}$$

The actual sieving coefficient Sₐ is obtained from

$${S}_{a} = \frac{{S}_{∞} exp ( P {e}_{m} )}{{S}_{∞} + exp ( P {e}_{m} ) - 1} \qquad ( 33 )$$

Finally, the observed sieving coefficient for the particle i through the membrane (Sₒₘₑₘ) is

$${S}_{omem} ( i ) = \frac{{S}_{a}}{( 1 - {S}_{a} ) exp ( \frac{- {J}_{actual}}{k} ) + {S}_{a}} \qquad ( 34 )$$

where the mass transfer coefficient is given by

$$k = \frac{{J}_{PI} ( i )}{ln ( \frac{{ϕ}_{wi}}{{ϕ}_{bi}} )} \qquad ( 35 )$$

according to the classic film model (Zeman et al., “Microfiltration and Ultrafiltration Principles and Applications,” Chapter 7, Marcel Dekker: New York (1996), which is hereby incorporated by reference in its entirety). The overall observed sieving coefficient for the particle through the deposit and the membrane is given by the product of the respective sieving coefficients:
Sₒ(i)=S_{odeposit}(i)Sₒₘₑₘ(i) (36)

7. Differential Equations of Solute Balance. The modules 1-6 of the algorithm of the present invention provide the methodology to predict the limiting value of the polydisperse pressure-independent permeation flux and solute sieving coefficients for any permeation flux. Thus, by varying permeation flux from very low values up to the limiting value, the entire range of MF/UF operations can be covered for a given pH and wall shear rate. MF/UF processes are dynamic. For example, the bulk concentration of all transmitted solutes in a constant volume diafiltration process (where the feed volume is maintained constant by buffer addition in the feed tank) changes continuously. This will lead to changes in solute transport and cake composition continuously with time. This is based on the assumption of no interaction between the membrane and solutes. Essentially, each reservoir in a MF/UF process is governed by n differential equations reflecting the mass balance of n solutes. These differential equations are coupled through the packing constraints of the deposit, system connectivity, and the viscosity of the suspension. In general, these differential equations cannot be solved analytically for complex systems involving multiple membrane stages and polydisperse suspensions involving many solutes and particles. This problem can be made tractable by assuming that the membrane process is in a quasi-equilibrium state for a short time step (e.g., 10 s) and writing the differential equations as algebraic difference equations. This entails that all calculations pertaining to suspension details, hydrodynamics, cake composition, and solute transport governed by modules 1, 3, 5, and 6 have to be carried out after every time step and this has to be repeated until the objective of the MF/UF process is achieved. While these calculations can, theoretically, be carried out by an individual, given the large number of calculations to be carried out, a computer program is recommended to solve for all the difference equations involved.

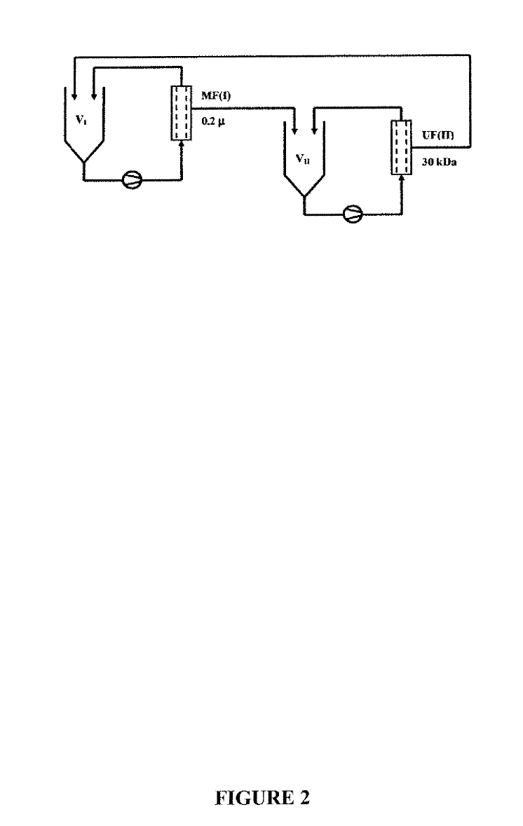

In summary, the difference equations for the solute balances can be written for a general MF/UF process of any complexity and mode of operation such as diafiltration, concentration, or any combination of the two. Thus, any MF/UF process in the laminar flow regime can be simulated and optimized. The present invention can be applied to a process having any number of reservoirs or comparable process chambers, and any number of particle types and target solutes species in the feed suspension. For example, the differential equation for the ith solute for the first reservoir I in a system of two membrane stages, run in constant diafiltration mode with internal circulation, such as the system shown in FIG. 2, is described below as a typical example:
V(1)dφ_{bi1}/dt=J(1)A(1)[φ_{bi2}Sₒ₂(i)−φ_{bi1}Sₒ₁(i)] (37)

For seven solutes and two reservoirs, there will be 14 differential equations of this type. Equation 37 is complex because the variables φ_{bi1}, φ_{bi2}, Sₒ₁(i), and Sₒ₂(i) are all functions of time and also interdependent. Therefore, Eq 37 is rewritten in the difference form as follows:

$$\begin{matrix} \frac{V ( 1 ) ⅆ {ϕ}_{bi 1}}{ⅆ t} & V ( 1 ) d {ϕ}_{bi 1}\end{matrix} \\ {ϕ}_{bi 1} ( t + Δ t ) = {ϕ}_{bi 1} ( t ) [ 1 - J ( 1 ) A ( 1 ) {S}_{o 1} ( i ) \frac{Δ t}{V ( 1 )} ] + {ϕ}_{bi 2} ( t ) [ J ( 2 ) A ( 2 ) {S}_{o 1} ( i ) \frac{Δ t}{V ( 1 )} ] \qquad ( 38 )$$

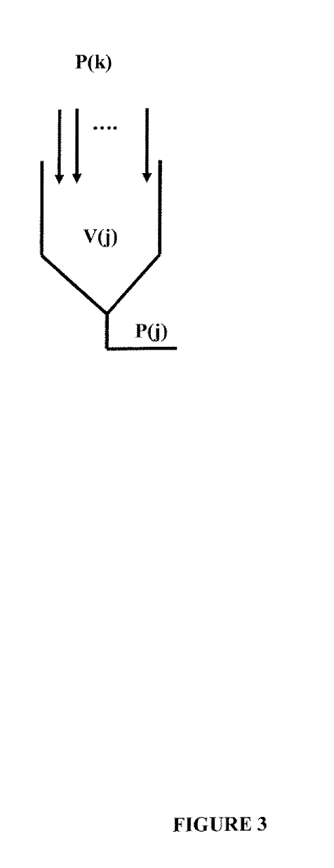

The global model of the present invention is meant to encompass a filtration system configuration of any size and design, without limitation as to number of possible target species (i), reservoirs (j), or membranes (n) utilized in the filtration system. Therefore, another aspect of the present invention, based on the algorithm and input parameters as describe above, is a generalized mass balance equation for calculating the difference equation for each solute (i) in each (j) reservoirs and n membranes using:
φ_{bij}(t+Δt)=φ_{bij}(t)+(1/V(j))[ΣP(k)φ_{bik}Sₒₖ(i)−Pⱼφ_{bij}Sₒⱼ(i)]Δt (42)
where P(k) is permeation rate in m³/s through the kth membrane and k=membrane numbers whose permeate is routed to reservoir (j) and k≠j. FIG. 3 shows the jth reservoir of an exemplary generalized crossflow filtration system containing n reservoirs and n membranes.

Once the initialization is completed, equations of this type can be readily solved by using a computer program. The computer, in effect, conducts in silico MF/UF experiments as it increments the process by arbitrarily small time steps (e.g., 10 s).

Therefore, another aspect of present invention is an algorithm for the global model for MF/UF disclosed herein, which is used to simulate and optimize an ultrafiltration process. This is illustrated by the exemplary flowchart shown in FIG. 1. Programs for this and other MF/UF processes were written in Fortran 77 to validate the global model and simulate various typical and challenging separations (“Global model for optimizing micro-filtration and ultra-filtration process,” U.S. Copyright Registration No. TXu-1-198-389 (5 Sep. 2004), which is hereby incorporated by reference in its entirety). The programs are self-contained and do not require separate input files. The programs are based on the modules described previously and annotated for easy reading.

The global model algorithm of the present invention can be implemented using a modeling system. The modeling system of the invention includes a general-purpose programmable digital computer system of special or conventional construction, including a memory and a processor for running a modeling program or programs. The modeling system may also include input/output devices, and, optionally, conventional communications hardware and software by which a computer system can be connected to other computer systems.

Therefore, one embodiment of the present invention is a computer readable medium having instructions stored thereon for diagnostic processing as described herein, which when executed by a processor, cause the processor to carry out the steps necessary to implement the methods of the present invention as described herein above.

This embodiment involves a computer readable medium which stores programmed instructions for predicting and optimizing operating conditions for yield of a target species, purity of a target species, selectivity of a target species and/or processing time for crossflow membrane filtration of a polydisperse feed suspension having one or more target species of solutes or particles. This medium includes machine executable code which, when provided as input parameters: size distribution of the particles and solutes in the suspension, concentration of particles and solutes in the suspension, suspension pH and temperature, membrane thickness, membrane hydraulic permeability (Lp), membrane pore size or molecular weight cut off, membrane module internal diameter, membrane module length, membrane area, membrane porosity, filtration system configuration, and reservoir volume (V); and executed by at least one processor, causes the processor to calculate the effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each target solute or particle species through cake deposit and pores of the membrane using the provided input parameters. The computer readable medium also causes the processor to solve the solute mass balance equation for each target solute or particle species in each reservoir of the feed suspension based on the provided size distribution of the particles and solutes in the suspension, concentration of particles and solutes in the suspension, suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and the calculated effective membrane pore size distribution (λ′), viscosity of the suspension, hydrodynamics of the suspension, electrostatics of the suspension, pressure-independent permeation flux (JPD) of the suspension and cake composition, pressure-independent permeation flux [J_{PI}(i)] for each particle (i) in the suspension, and overall observed sieving coefficient of a particle through cake deposit and pores of the membrane. The computer readable medium also causes the processor to iterate the solute mass balance equation for each species at all possible permeation fluxes to determine time, yield, selectivity, and processing time of crossflow filtration. The computer readable medium of present invention also causes the processor to analyze the results of the mass balance equations and predict the operating conditions that optimize for yield of a target species, selectivity of a target species, purity of a target species, and/or processing time, thereby predicting and optimizing operating conditions of crossflow membrane filtration of a polydisperse feed suspension containing one or more target solute or particle species.

Because the calculations requisite for applying the global model of the present invention can be carried out so quickly using a computer program, the parameters for the feed suspension and filtration process can be varied using in silico simulations, rather than actual small scale experiment, to design optimized operating conditions. This has the potential for saving considerable time, labor, and materials.

In some embodiments, the global model algorithm of the present invention can be implemented on a single computer system.

In a related embodiment, the functions of the global model of the invention can be distributed across multiple computer systems, such as on a network. Those skilled in the art will recognize that the model of the invention can be implemented in a variety of ways using known computer hardware and software, such as, for example, a Silicon Graphics Origin 2000 server having multiple RI 0000 processors running at 195 MHz, each having 4 MB secondary cache, or a dual processor Dell PowerEdge system equipped with Intel PentiumIII 866 MHz processors with 1 Gb of memory and a 133 MHz front side bus. More advanced and/or powerful systems are constantly being produced, and are all commercially available.

In some embodiments, the steps of the global model of the present invention can be implemented by a computer system comprising modules, each adapted to perform one or more of the steps. Each module can be implemented either independently or in combination with one or more of the other modules. A module can be implemented in hardware in the form of a DSP, ASP, reprogrammable ROM device, or any other form of integrated circuit, in software executable on a general or special purpose computing device, or in a combination of hardware and software.

In addition, two or more computing systems or devices can be substituted for any one of the systems in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on computer system or systems that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention can be implemented in digital electronic circuitry, or in computer hardware, firmware, software, or combinations thereof. The invention can be implemented advantageously in one or more computer readable mediums that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Furthermore, each of the systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

It is to be understood that the devices and systems of the exemplary embodiments are for exemplary purposes, as many variations of the specific hardware and software used to implement the exemplary embodiments are possible, as will be appreciated by those skilled in the relevant art(s).

The global MF/UF model was validated successfully with three test cases: (a) separation of BSA from Hb by UF (Bailey et al., “Cross-Flow Microfiltration of Recombinant E-Coli Cell Lysates After High-Pressure Homogenization,” Biotechnol Bioeng 56:304-310 (1997), which is hereby incorporated by reference in its entirety), (b) capture of IgG from transgenic goat milk by MF (Baruah et al., “Optimized Recovery of Monoclonal Antibodies from Transgenic Goat Milk by Microfiltration,” Biotechnol Bioeng 87:274-285 (2004), which is hereby incorporated by reference in its entirety), and (c) separation of BSA from IgG by UF (Saksena et al., “Effect of Solution pH and Ionic Strength on the Separation of Albumin from Immunoglobulins by Selective Filtration,” Biotechnol Bioeng 43:960-968 (1994), which is hereby incorporated by reference in its entirety). The validation experiments of the global model for MF/UF are described in detail in the Examples, below.

### EXAMPLES

### Example 1

### Validation of Algorithm in Separation of Hemoglobin and Bovine Serum Albumin in Batch Ultrafiltration Model

The first filtration validation test case described here is the separation of bovine serum albumin (BSA) and hemoglobin (Hb) based on Raymond et al., “Protein Fractionation Using Electrostatic Interactions in Membrane Filtration,” Biotechnol Bioeng 48:406-414 (1995) (which is hereby incorporated by reference in its entirety). In this specific situation, the UF process is operated at the pI of Hb (pH=6.8) and the BSA charge is given as −17.5 electronic charges (Raymond et al., “Protein Fractionation Using Electrostatic Interactions in Membrane Filtration,” Biotechnol Bioeng 48:406-414 (1995), which is hereby incorporated by reference in its entirety). In the absence of specific data for the 100 kDa membrane, such as the thickness and porosity, typical values used were based on membrane characteristics for protein crossflow filtration as described by Zeman et al., “Microfiltration and Ultrafiltration Principles and Applications,” Chapter 12, Marcel Dekker: New York (1996), which is hereby incorporated by reference in its entirety) and Pujar et al., “Electrostatic Effects on Protein Partitioning in Size-Exclusion Chromatography and Membrane Ultrafiltration,” J Chromatogr A 796:229-238 (1998) (which is hereby incorporated by reference in its entirety).

The packing constraints in module 5 necessarily have to be case-specific, as they are based on geometry of the cake. In this case, the two solutes are of comparative sizes (within a factor of 10), even though the effective size of the BSA molecule could be much larger at low ionic strengths. Hence, the packing constraints are chosen to be
φᵢ≦0.64 (39)
Σφᵢ≦0.68 (40)

Two versions of the program were prepared, version A and version B. Version A was used to evaluate the maximum selectivity between Hb and BSA with BSA in the retentate and Hb in the permeate (i.e., to determine the sieving coefficients of Hb and BSA). As the programs were set up in the diafiltration mode, the batch filtration mode is simulated by setting a low time limit of 5 time steps or 50 s for each in silico experiment. Thus, the bulk concentrations in the feed reservoir are practically constant as in the batch filtration case, with recycle of permeate back to the feed reservoir. The highest selectivity for a given ionic strength was evaluated by choosing increasing permeation flux values from 1.8 Lmh up to the pressure-independent permeation flux of this binary system. Version B was used to simulate a 3-diavolume diafiltration process as per the actual experiments of Zydney et al. (Raymond et al., “Protein Fractionation Using Electrostatic Interactions in Membrane Filtration,” Biotechnol Bioeng 48:406-414 (1995), which is hereby incorporated by its entirety) at the same concentrations. All variables were in S.I. units except particle and pore radii in nm, membrane areas in cm², membrane module internal diameter in mm, and membrane thickness in nm. For version B, an in silico experiment was terminated after the permeation volume reached 3 times the system volume.

The above example is meant to be illustrative. Instead of developing an all encompassing program to cater to all conceivable situations, it is considered more expedient to develop a generic basic program structure and then tailor it to specific cases by a few modifications usually in the way the program is terminated or by the way the packing constraints are set up. In summary, crossflow MF/UF processes operating in the laminar regime in both the pressure-dependent and pressure-independent regimes can be modeled using the above methodology. The basic philosophy could be extended to the turbulent regime by modifying the back-transport equations.

The global model is first validated with experimental results from several researchers and then used to conduct various in silico experiments to mimic typical MF/UF scenarios. These simulations are used to investigate the effects of pH, ionic strength, membrane pore size, membrane wall shear rate, and permeation flux on MF/UF performance parameters such as selectivity of one solute over the other, diafiltration time, yield, and purity. Finally, the model is used to simulate novel challenging separations such as hemoglobin from its charge-variant mutant and immunoglobulins from transgenic milk using normal and shear-enhanced helical membrane modules.

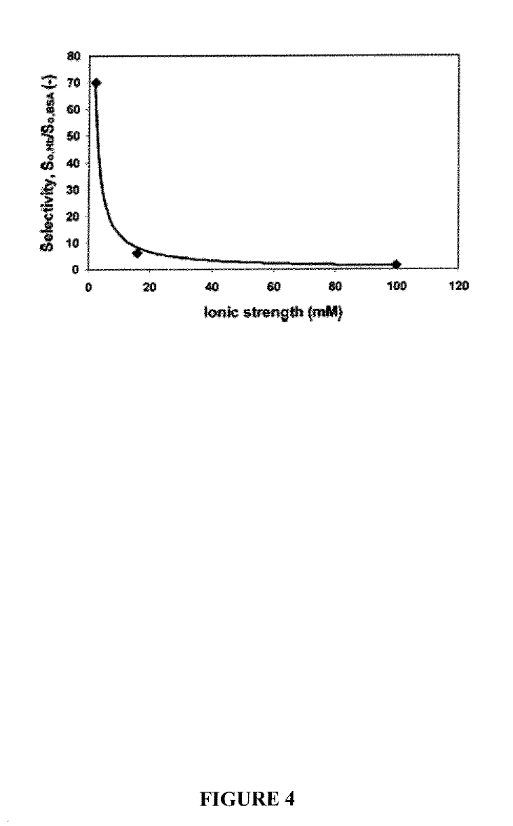

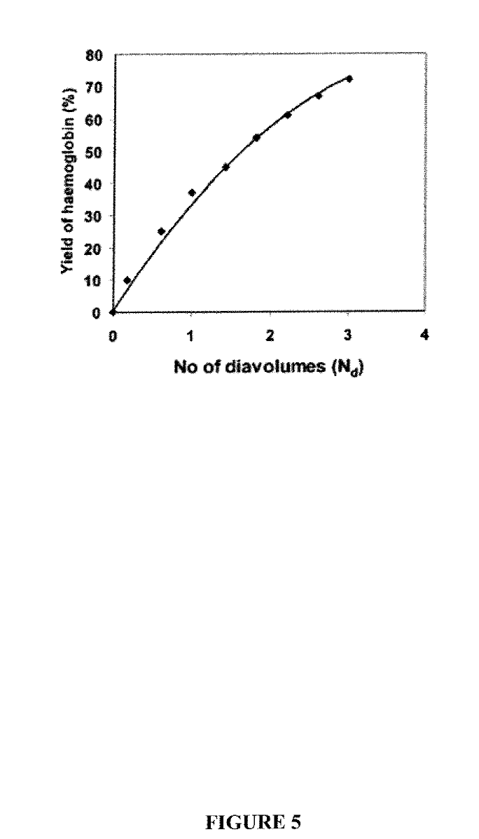

The first case has been discussed briefly herein above. The goal of this study was to separate two proteins, BSA and Hb, which have similar molecular weights of 69 and 67 kDa but very different pI values, 4.7 and 6.8, respectively. The simulation was conducted by considering the actual membrane parameters such as MWCO of 100 kDa, hydraulic permeability of 1.9×10⁻⁹ m/s-Pa and assumed membrane thickness of 0.5 μm and porosity of 0.3 based on typical values given in the literature (Pujar et al., “Electrostatic Effects on Protein Partitioning in Size-Exclusion Chromatography and Membrane Ultrafiltration,” J Chromatogr A 796:229-238 (1998), which is hereby incorporated by reference in its entirety). The charge of BSA at the experimental conditions of 6.8 pH was indicated as −17.5 electronic charges, whereas Hb was neutral. The actual experiments were conducted to identify the highest selectivity between Hb and BSA with Hb in the permeate and BSA in the retentate at ionic strengths of 2.3, 16, and 100 mM in a batch filtration experiment with bulk Hb and BSA concentrations maintained constant. The simulations were conducted for a large number of ionic strengths between 1.8 and 100 mM to determine the highest selectivity at each ionic strength by varying the permeation flux rates. The bulk protein concentrations were kept identical to the experimental values of 1.2 g/L for Hb and 10 g/L for BSA. As seen in FIG. 4, the model-generated curve captures the highly asymptotic experimental data very well. Zydney's group (Raymond et al., “Protein Fractionation Using Electrostatic Interactions in Membrane Filtration,” Biotechnol Bioeng 48:406-414 (1995), which are hereby incorporated by reference in their entirety) also conducted diafiltration of the Hb-BSA mixture at 3.2 mM ionic strength, permeation flux of 9 Lmh and a pH of 7.1. The actual yields of Hb in the permeate are compared to the model generated values at 3.2 mM ionic strength, permeation flux of 14 Lmh and a pH of 7.1 in FIG. 5 for different diavolumes (permeate volume/retentate loop volume). A small charge of −1.5 electronic units was taken for Hb as the experiment was conducted at pH of 7.1, which is higher than the pI of Hb of 6.8. The model predicts the yield values of Hb very well, especially as there were no fitting parameters.

### Example 2

### Validation of Algorithm in Optimized Recovery of IgG From Transgenic Goat Milk in Microfiltration Model

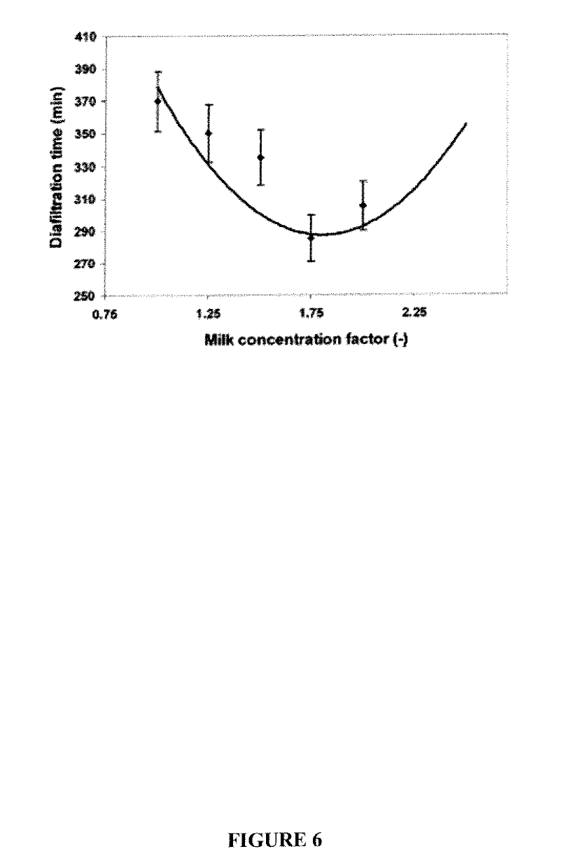

The second validation test case involves the optimized recovery of IgG from transgenic goat milk (TGM) (Baruah et al., “Optimized Recovery of Monoclonal Antibodies from Transgenic Goat Milk by Microfiltration,” Biotechnol Bioeng 87:274-285 (2004), which is hereby incorporated by reference in its entirety). This extremely complicated polydisperse suspension was modeled as a suspension comprising fat globules and casein micelles of radii 300 and 180 nm, respectively, along with the principal whey proteins such as α-lactalbumin, β-lactoglobulin, serum albumin, and transgenic IgG apart from lactose. It was assumed that the MF membrane (0.1 μm) would allow 100% transmission of salts, hence, salts were not considered. The experiments were designed to find the lowest diafiltration time by varying the permeation flux and milk concentration factors. The diafiltration simulations mimicked the actual experiments conducted at pH of 9 (pI of transgenic IgG) at a low ionic strength (7.5 mM) of TGM (Le Berre et al, “Microfiltration (0.1 μm) of Milk: Effect of Protein Size and Charge,” J Dairy Res 65:443-455 (1998), which is hereby incorporated by reference in its entirety). The MF module was helical with a filtration area of 32 cm² with a retentate loop volume of 85 mL for the experiments as well as the computer simulations. The charges on the non-IgG whey proteins were calculated on the basis of the Henderson-Hasselbach equation as described in module 4 of the global model. As seen in FIG. 6, there is a good fit between experimental data and the model-generated curve. Again, no fitting parameters were used.

### Example 3

### Validation of Algorithm in Separation of IgG from Bovine Serum Albumin in Batch Ultrafiltration Model

The third validation test case is the separation of IgG from BSA by Saksena and Zydney (Saksena et al., “Effect of Solution pH and Ionic Strength on the Separation of Albumin from Immunoglobulins by Selective Filtration,” Biotechnol Bioeng 43:960-968 (1994), which is hereby incorporated by reference in its entirety). Various experiments were conducted in this study, but the unusual case was chosen, where a 300 kDa membrane was used to pass neutral IgG (155 kDa) while the smaller charged BSA (69 kDa) was retained. At an ionic strength of 150 mM NaCl and a permeation flux of 18 Lmh, the model predicted selectivity of IgG over BSA as 1.1. This agrees with the experimental value of 1.0. However, at an ionic strength of 15 mM the model predicts a selectivity of 3.4 versus 2.8 achieved experimentally at 1.5 mM. Thus, there is qualitative agreement in the low ionic strength case also.

Thus, the global model of the present invention was successfully validated with widely different practical studies involving a range of pH, ionic strength, membranes, and suspension types from simple binary to complex polydisperse cases.

### Example 4

### Model Predictions: Ionic Strength and pH

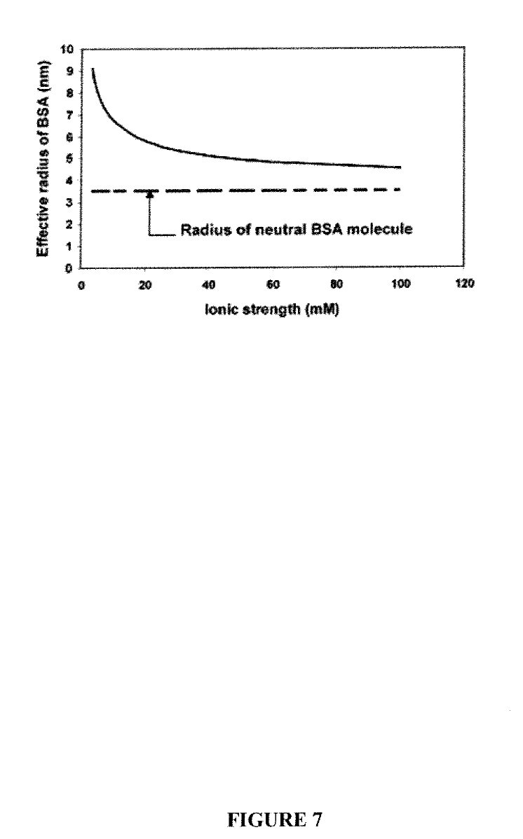

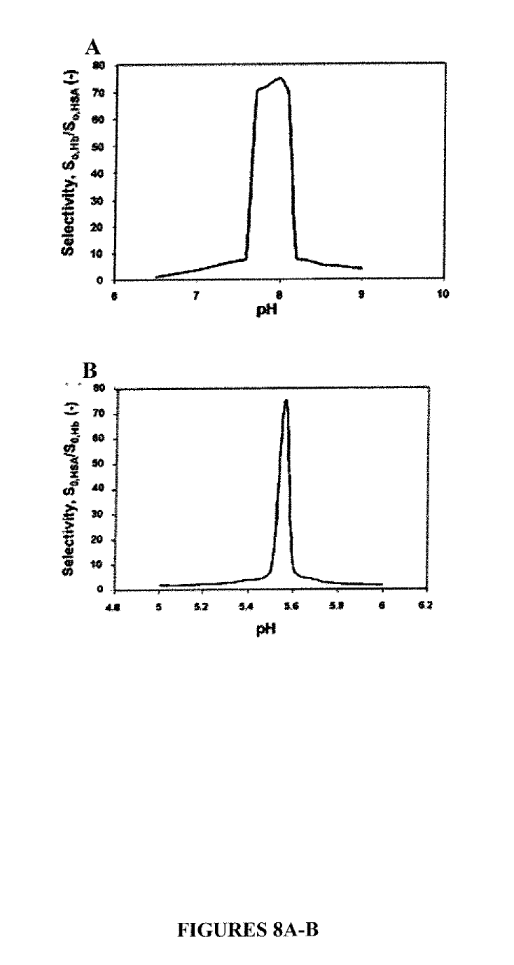

As noted herein above, it is clear that solute charge and the ionic strength of the solution/suspension are of crucial importance in both UF/MF. In the case of UF this has been amply demonstrated by a number of researchers (van Reis et al., “High Performance Tangential Flow Filtration,” Biotechnol. Bioeng 56:71-82 (1997); Cherkasov et al., “The Resolving Power of Ultrafiltration,” J Membr Sci 110:79-82 (1996); DiLeo et al., “High-Resolution Removal of Virus from Protein Solutions Using a Membrane of Unique Structure,” Bio/Technology 10:182-188 (1992); Muller, et al., “Ultrafiltration Modes of Operation for the Separation of R-Lactalbumin from Acid Casein Whey,” J Membr Sci 153:9-21 (1999); Rabiller-Baudry et al., “Application of a Convection-Diffusion-Electrophoretic Migration Model to Ultrafiltration of Lysozyme at Different pH Values and Ionic Strengths,” J Membr Sci 179:163-174 (2000); Nystrom et al., “Fractionation of Model Proteins Using Their Physicochemical Properties,” Colloids Surf 138:185-205 (1998); Saksena et al., “Effect of Solution pH and Ionic Strength on the Separation of Albumin from Immunoglobulin-(IgG) by Selective Filtration,” Biotechnol Bioeng 43:960-968 (1994); Pujar et al., “Electrostatic Effects on Protein Partitioning in Size-Exclusion Chromatography and Membrane Ultrafiltration,” J Chromatogr A 796:229-238 (1998); Raymond et al., “Protein Fractionation Using Electrostatic Interactions in Membrane Filtration,” Biotechnol Bioeng 48:406-414 (1995), which are all hereby incorporated by reference in their entirety). This was also demonstrated to be valid for MF by Baruah and Belfort (Baruah et al., “Optimized Recovery of Monoclonal Antibodies from Transgenic Goat Milk by Microfiltration,” Biotechnol Bioeng 87:274-285 (2004), which is hereby incorporated by reference in its entirety). This is because in MF the cake layer on the membrane acts like a secondary UF membrane. As was evident in the validation cases, this important aspect is captured by the global model of the present invention. For instance, in the case of the separation of similar sized Hb and BSA, an extremely high selectivity of 70 was obtained at around 2 mM ionic strength with divalent ions, as shown in FIG. 4. A reasonable selectivity of 7.5 is obtained even at 10 mM ionic strength. In the global model, this aspect is captured by an effective radius of a charged solute. The effective radius of a BSA molecule (−17.5 electronic charges) is plotted against the solution ionic strength, shown in FIG. 7. It is seen that the apparent size of the BSA molecule increases up to ˜4 times its uncharged radius (3.5 nm) at an ionic strength of 1.8 mM due to the cloud of counterions and the force field of the charged molecule. It has been experimentally observed in the past that sized-based membrane separations are possible only for particles differing in molecular weight by at least a decade (i.e., 10×) (Nystrom et al., “Fractionation of Model Proteins Using Their Physicochemical Properties,” Colloids Surf 138:185-205 (1998), which is hereby incorporated by reference in its entirety). In terms of radius, this would imply that a neutral particle of radius=(10)^{1/3}×3.5=7.5 nm could be separated from a neutral BSA molecule. This is borne out by FIGS. 3 and 6, which indicate a reasonable selectivity of 10.5 between a particle of effective radius 7.5 nm and a particle of effective radius 3.5 nm. The effect of charge is most pronounced for small solutes at low ionic strength and low valency of counterions. In the case of BSA, the effect persists up to 100 mM where the apparent radius at 4.5 nm is still 29% larger than that of the neutral molecule. For a given low ionic strength, the operating pH is very important. This effect is studied by simulating a hypothetical binary mixture of human serum albumin (HSA) and human hemoglobin (Hb). The charges at various pH values were estimated by using the H-H equation as described in module 4 of the global model and the sequence of amino acids given by the Protein Data Bank (PDB-1 ao6-A for HSA and PDB-1 a3N-A to D for Hb, which are hereby incorporated by reference in their entirety). These simple charge estimation calculations yield a pI of HSA as 5.56 and pI of Hb as 7.9. Aside from the slight difference in calculated and actual pI values of these protein molecules, it is seen from FIG. 8A that selectivities in the region of 70 can be obtained between Hb and HSA in a band of pH values ranging from 7.7 to 8.1. The reverse situation is seen between HSA and Hb at the pI of HSA, as shown in FIG. 8B. Here the band of high selectivities is much narrower because of the ionization of residues near the pI for HSA.

### Example 5

### Effect of Membrane Pore Size

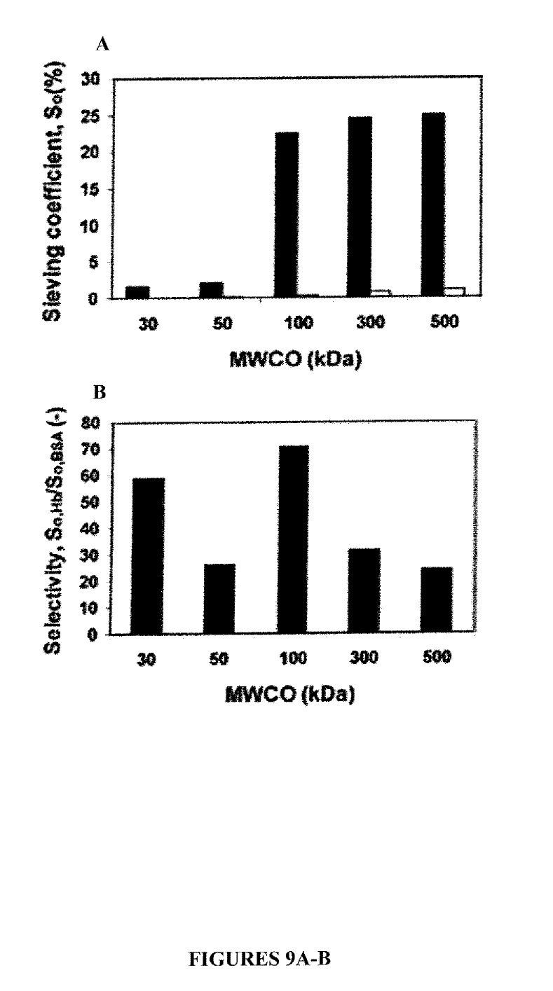

The effect of membrane pore size was studied by conducting simulations of the Hb-BSA separation at 1.8 mM ionic strength and pH 6.8 for membranes having molecular weight cut offs (MWCO) 30, 50, 100, 300, and 500 kDa, as shown in FIGS. 8A-B. The average value of 0.2 for the λ′(1−λ′) term was considered for evaluating a_{effective} to reduce artifacts due to large differences in membrane pore sizes (Pujar et al., “Electrostatic Effects on Protein Partitioning in Size-Exclusion Chromatography and Membrane Ultrafiltration,” J Chromatogr A 796:229-238 (1998), which is hereby incorporated by reference in its entirety). Note that the plotted sieving coefficients and selectivities correspond to the permeation flux that gives the highest selectivity of Hb over BSA. As seen in FIG. 9A, the sieving coefficient coefficients for both BSA and Hb go on increasing with increasing MWCO of the membranes. This was to be expected, as the pore sizes increase with increasing MWCO and, hence, greater sieving through the membrane occurs. The sieving coefficient for Hb dropped sharply to around 2.5% for MWCO<100 kDa and was above 20% for 100 kDa and above. The maximum selectivity (ratio of sieving coefficients) of 70 was achieved for the 100 kDa cut off membrane, but the more open membranes, such as the 300 and 500 kDa membranes, also gave reasonable selectivities of 32 and 25 respectively, as shown in FIG. 9B. This result is due to the large swelling of the apparent size of the highly charged BSA molecule which results only in around 1% transmission of BSA for even the 300 and 500 kDa membranes.

### Example 6

### Effect of Permeation Flux

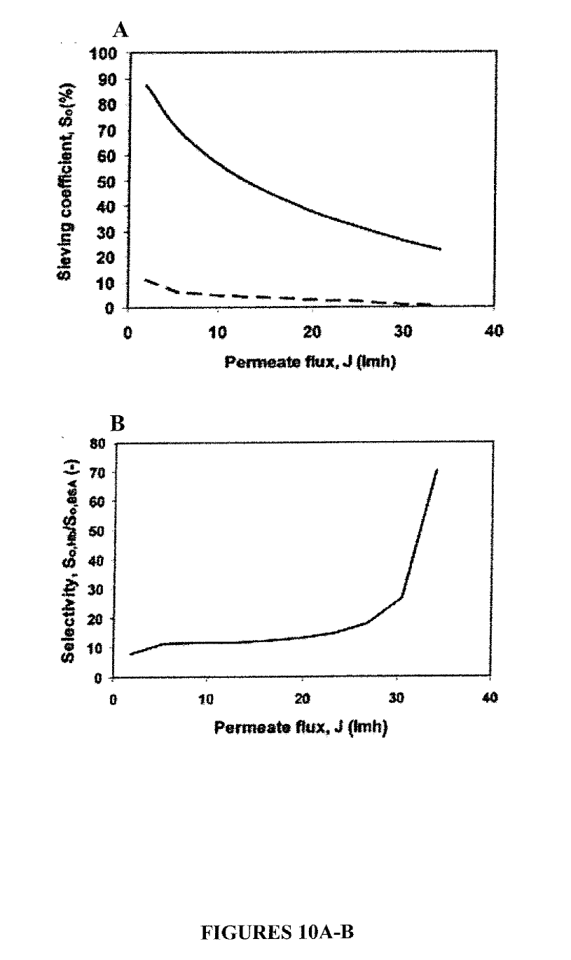

The effect of permeation flux on selectivity is crucial. In MF/UF operations two “membranes” effectively exist in series. A first “membrane” is created by the dynamic deposit of particles on the membrane wall. The second “membrane” is the actual MF or UF component membrane itself. The global model of the present invention evaluates the sieving coefficient for a solute through each of these. For the membrane, the sieving coefficient is high at low permeation flux, drops to a minimum, and then rises again at higher permeation rates as a result of concentration polarization (Zeman et al., “Microfiltration and Ultrafiltration Principles and Applications,” Chapter 7, pg 370-372, Marcel Dekker: New York (1996) which is hereby incorporated by reference in its entirety). This effect is captured in Eqs 30-35. For the deposit, the sieving coefficient decreases monotonically with increasing permeation rate because the deposit becomes more tightly packed at higher permeation fluxes. The overall effect is evaluated by taking the product of the sieving coefficients through the membrane and the deposit (Eq 36). Thus, the trend of sieving coefficient of a solute through a membrane will be case-specific because of these opposing tendencies. For the simulated case of Hb/BSA the observed sieving coefficients drop continuously with increasing permeation flux, as depicted in FIG. 10A. The best selectivity of 70, in this particular case, is achieved close to the pressure independent flux of the binary mixture as seen in FIG. 10B. This is not a general result. Depending on the relative sizes of the molecules being separated and the solution conditions the highest values of selectivity could be at low permeation flux.

### Example 7

### Effect of Shear Rate

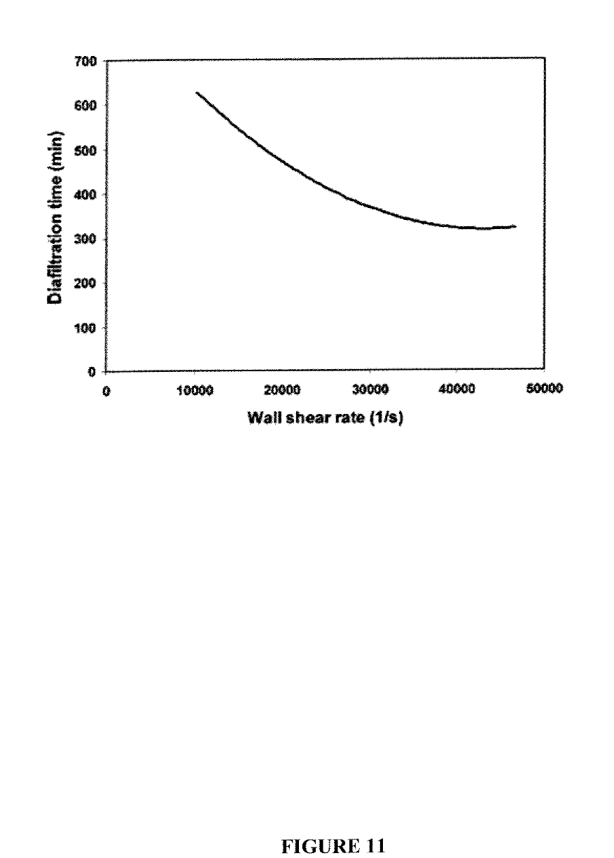

The operating wall shear is very important because higher shear rates give rise to higher back-transport of particles from the membrane wall leading to sparser deposits and higher solute and solvent transport through the membrane/cake complex. However, it has been shown that there is a limit to the beneficial effects of high shear rates (Baruah et al., “A Predictive Aggregate Transport Model for Microfiltration of Combined Macromolecular Solutions and Poly-Disperse Suspensions: Model Development,” Biotechnol Prog 19:1524-1532 (2003), Baruah et al., “A Predictive Aggregate Transport Model for Microfiltration of Combined Macromolecular Solutions and Poly-Disperse Suspensions: Testing Model with Transgenic Goat Milk,” Biotechnol Prog 19:1533-1540 (2003), which are hereby incorporated by reference in their entirety). At very high shear rates, the phenomenon of fines incrustation in the cake occurs. In short, at very high shear rates the bigger particles are lifted off by shear-induced diffusion and inertial lift mechanisms, whereas the smaller particles that are governed by Brownian diffusion are not lifted off as readily. This is because the dependency of back-transport on shear rate is γ^{1/3} for Brownian diffusion, γ for shear-induced diffusion, and γ² for inertial lift (applicable for a >20 μm) as per Eqs 1-3. Here, the effect of shear rate was studied by conducting MF diafiltration simulations on milk at different shear rates and optimizing the process for the minimum diafiltration time for a fixed yield of 95% for IgG in the permeate. These diafiltration times are plotted against the wall shear rate in FIG. 11. Interestingly, the diafiltration time decreases with increasing shear rate and hits a minimum at around 40,000 s⁻¹ before slowly rising again. This coincides with the phenomenon of cake transition from coarse to fine, which results in low solute transmission (Baruah et al., “A Predictive Aggregate Transport Model for Microfiltration of Combined Macromolecular Solutions and Poly-Disperse Suspensions: Model Development,” Biotechnol Prog 19:1524-1532 (2003), Baruah et al., “A Predictive Aggregate Transport Model for Microfiltration of Combined Macromolecular Solutions and Poly-Disperse Suspensions: Testing Model with Transgenic Goat Milk,” Biotechnol Prog 19:1533-1540 (2003), which are hereby incorporated by reference in their entirety) through the deposit/membrane. This phenomenon was also reported for experiments by Baker et al., “Factors Affecting Flux in Crossflow Filtration,” Desalination 53:81-93 (1985), which is hereby incorporated by reference in its entirety.

### Example 8

### Separation of Charge Variants

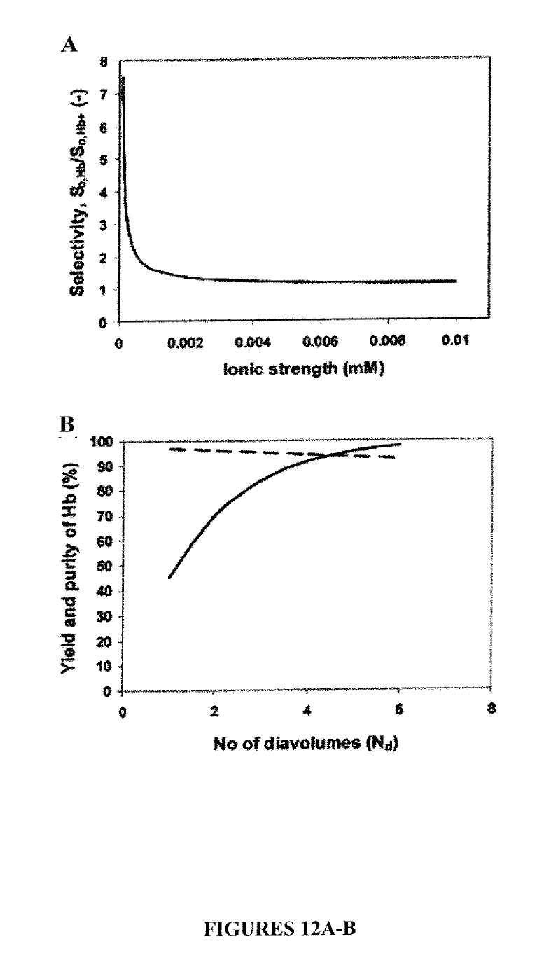

To check the feasibility of separating proteins from their charged variants, a hypothetical mixture of Hb and a mutant Hb (Hb+) with the substitution of an alanine residue by a lysine residue was studied. For a mixture containing 1 g/L of Hb and 0.2 g/L of Hb+ the simulation was conducted with a 100 kDa membrane at various ionic strengths of NaCl at pH 6.8 the pI of Hb. Lysine substitution resulted in an additional positive charge on the mutant form of 1 electronic unit at pH 6.8. Under these conditions, simulation results indicate that it is possible to obtain a selectivity of 7, as shown in FIG. 12A, at very low ionic strengths. Furthermore, the simulation results for a constant volume diafiltration are plotted in FIG. 12B. In this case, an interesting tradeoff between yield and purity is demonstrated. Thus, if a purity of 98% of native Hb is desired in the permeate stream, diafiltration should be stopped after just 1 diavolume with a low yield of 45%.

However, if 95% purity is adequate, the diafiltration process could be continued for 4 diavolumes with a yield of 90%.

### Example 9

### Capture of Proteins from Complex Polydisperse Suspensions

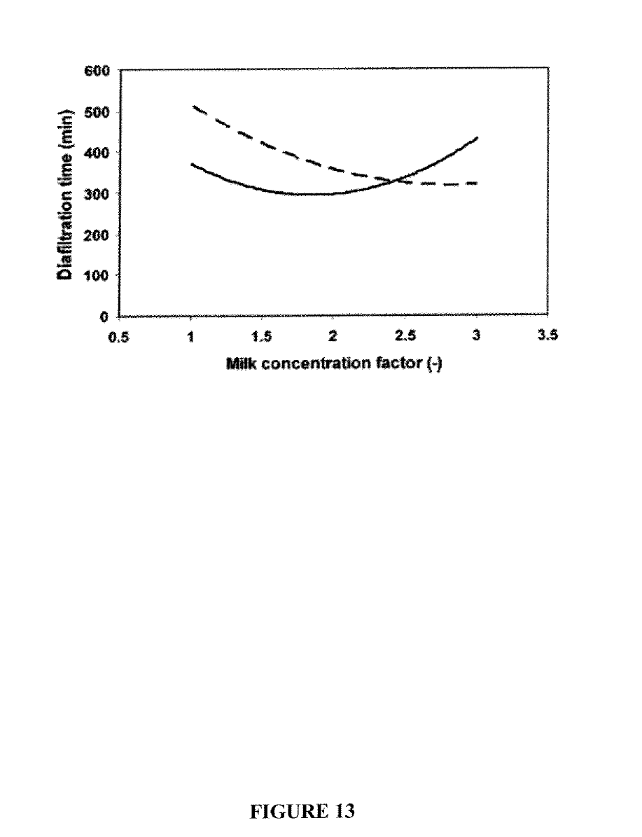

As indicated above, most real suspensions that need to be filtered are polydisperse and complex. Biological broths and milk are typical examples of such suspensions. Simulation of the capture of IgG from transgenic milk was taken as a test case to validate the global model for MF/UF (as described in Example 2, above). As another example of this complex MF process, simulations with a linear MF module was conducted and compared with a shear-enhanced helical module (U.S. Pat. RE 37,759 to Belfort, G., which is hereby incorporated by reference in its entirety). As shown in FIG. 13, the helical MF module takes less time to filter and recover 95% of the IgG product and is thus superior to the linear module in terms of diafiltration time. This is supported by experimental data presented in Baruah et al., “Optimized Recovery of Monoclonal Antibodies from Transgenic Goat Milk by Microfiltration,” Biotechnol Bioeng 87:274-285 (2004), which is hereby incorporated by reference in its entirety.

### Example 10

### Computer Model Based on Algorithm

Although there have been numerous advances in membrane theory and application in the past decade, it has not previously been possible to a priori predict and optimize MF/UF processes. The main hurdles have been an absence of solute transport theory in the pressure-dependent regime of operation, how to incorporate polydispersity/complexity of the suspension, a simple way of handling colloidal interactions, and a formulation that includes the variability of solute transport during the progress of the filtration process. This has resulted in the anachronistic situation where MF/UF process design and optimization is largely empirical in this era of computation technology. This leads to a large investment of time during process evolution and/or nonoptimal MF/UF processes.

The present invention addresses this crucial issue by presenting a global model for MF/UF, which can simulate and optimize crossflow MF/UF processes with polydisperse/complex suspensions operated in the laminar regime in an a priori sense with no fitting parameters. These conditions represent a major proportion of industrial MF/UF processes. The algorithm developed here could be extended to the turbulent regime by incorporating the applicable mass transfer equations. The methodology of the present invention was used to write computer programs for a wide spectrum of MF/UF operations ranging from the separation of proteins in a simple binary mixture, of a protein from its charge variant mutant, and of proteins recovered from complex polydisperse suspensions comprising more than 7 different solutes, such as transgenic milk. Although the model incorporates the crucial aspects of MF and UF rigorously, computer simulations of complex membrane processes incorporating multiple steps such as concentration followed by diafiltration and featuring several MF/UF modules can be completed in a few minutes. The generality of the model was reinforced by validation with experimental data from various researchers for three test cases: separation of BSA from hemoglobin by UF, capture of IgG from transgenic goat milk by MF, and separation of BSA from IgG by UF. In summary, a computer simulation model for predicting and optimizing MF/UF processes called the Global Predictive and Design model was, firstly, developed to account for (a) pH, ionic strength, and pI, (b) membrane pore size variation, (c) different membrane molecular weight cut offs, (d) solute polydispersity, (e) sieving through the deposit, (f) variable sieving coefficients, (g) complex membrane configurations and (h) any optimization task including yield of a target species, purity, selectivity, or processing time. Second, the model was validated for a wide variety of process applications. Finally, the model is used to fill the gaps in current MF/UF theory, making realistic and rapid in silico MF/UF optimizations with various membranes and operating conditions possible.

The global model for MF/UF is a facile design/optimization tool that allows the practitioner to drastically reduce experiments and enable him/her to choose and optimize from a wide variety of membranes and process configurations within a very short time frame. This work could be extended in the future to incorporate charged membranes, various module geometries, and turbulent flow.

Although the invention has been described in detail for the purpose of illustration, it is understood that such details are solely for that purpose and that variations can be made therein by those skilled in the art without departing from the spirit of the scope of the invention which is defined by the following claims.

What is claimed:

1. A method for determining optimum operating conditions for yield of a target species, purity of a target species, selectivity of a target species and/or processing time for crossflow membrane filtration of a polydisperse feed suspension comprising one or more target solute or particle species, said method comprising:
providing as input parameters: size distribution of the particles and solutes in the suspension, concentration of particles and solutes in the suspension, suspension pH and temperature, membrane thickness, membrane hydraulic permeability (Lp), membrane pore size or molecular weight cut off, membrane module internal diameter, membrane module length, membrane area, membrane porosity, filtration system configuration, and reservoir volume (V);
determining effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each target solute or particle species through cake deposit and pores of the membrane using said provided input parameters;
solving a solute mass balance equation for each target species in each reservoir of the feed suspension based on said provided size distribution of the particles and solutes in the suspension, concentration of particles and solutes in the suspension, suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and said determined effective membrane pore size distribution (λ′), viscosity of the suspension, hydrodynamics of the suspension, electrostatics of the suspension, pressure-independent permeation flux (JPD) of the suspension and cake composition, pressure-independent permeation flux [J_{PI}(i)] for each particle (i) in the suspension, and overall observed sieving coefficient of a particle through cake deposit and pores of the membrane; and
iterating the solute mass balance equation for each species at all possible permeation fluxes to determine purity, yield, selectivity, and/or processing time of crossflow filtration of the target species, thereby determining operating conditions that optimize for yield of a target species, selectivity of a target species, purity of a target species, and/or processing time for crossflow membrane filtration of a polydisperse feed suspension comprising one or more target solute or particle species.

2. The method according to claim 1, wherein said filtration system configuration comprises:
number of reservoirs in the filtration system;
number of membranes in the filtration system; and
connectivity of the filters and reservoirs.

3. The method according to claim 1, wherein said determining viscosity of the suspension is carried out using a modified Einstein-Smoluchowski equation: η/η₀=1+2.5φ_{b}+k₁φ_{b}², wherein η is bulk fluid viscosity (kg/m·s) of the suspension, η₀ is bulk fluid viscosity of the suspension without solute (kg/m·s), k₁ is particle shape factor (−), and φ_{b} is particle volume fraction in the bulk suspension (−).

4. The method according to claim 1, wherein said determining viscosity of the suspension is carried out by experimentation.

5. The method according to claim 1, wherein said determining effective membrane pore size distribution (λ′) is carried out using the equation: λ′=1−exp(−a/2s), where s=(5ηδₘLₚ/ε₁)^{1/2}, a is solute particle size, η is bulk fluid viscosity (kg/m·s), δₘ is membrane/cake thickness (m), Lₚ is hydraulic permeability of the membrane (m/s-Pa), and ε₁ is cake/membrane porosity (−)

6. The method according to claim 1, wherein said determining the hydrodynamics of the suspension comprises calculating wall shear rate as
$$γ = \frac{8 {V}_{axial}}{d} ,$$
where Vₐₓᵢₐₗ is axial velocity in membrane bore (m/s) and d is internal diameter of membrane module bore (nm).

7. The method according to claim 1, wherein said determining the hydrodynamics of the suspension comprises:
calculating wall shear rate as obtained by
$$γ = \frac{8 {V}_{axial}}{d} ,$$
where Vₐₓᵢₐₗ is obtained by back-calculation from a specified Reynold's number (Re), where
$$Re = \frac{ρ d {V}_{axial}}{{η}_{0} ( 1 + 2.5 {ϕ}_{b} + {k}_{1} {ϕ}_{b}^{2} )} ,$$
where η₀ is bulk fluid viscosity of the suspension without solute (kg/m·s), k₁ is particle shape factor (−), and φ_{b} is particle volume fraction in the bulk suspension (−).

8. The method according to claim 6, wherein the membrane is selected from the group consisting of a linear membrane and a shear-enhanced helical membrane.

9. The method according to claim 8, wherein the membrane is a shear-enhanced helical membrane.

10. The method according to claim 9, wherein said determining the hydrodynamics of the suspension further comprises multiplying γ by 1.95 to obtain the wall shear rate.

11. The method according to claim 1, wherein said determining electrostatics of the suspension comprises:
determining pI and charge of each particle in the suspension;
selecting pH of the suspension;
selecting ionic strength of the suspension;
selecting the valency (Z) of ions in the suspension; and
obtaining the effective solute radius (a_{effective}) for each particle, using said determined pI and charge of each particle in the suspension, said selected pH and ionic strength of the suspension, and said valency (Z) of ions in the suspension, thereby determining the electrostatics of the suspension.

12. The method according to claim 11, wherein said obtaining the effective solute radius (a_{effective}) comprises calculating:
$${a}_{effective} = a + ( \frac{4 {a}^{3} {σ}_{s}^{2}}{{ɛɛ}_{0} {k}^{′} T} ) {λ}^{′} ( 1 - {λ}^{′} ) {κ}^{- 1} ,$$
where λ′ is given as
$${λ}^{′} = 1 - exp ( \frac{- a}{2 s} ) ;$$
κ⁻¹ is given as
$${κ}^{- 1} = {( \frac{ɛ RT}{{Fa}^{2} \sum {Z}_{i}^{2} {C}_{i}} )}^{1 / 2} ;$$
$${σ}_{s} = no . of charges \times \frac{e}{4 π {a}^{2}} ,$$
where colloids are assumed spherical, and wherein a is radius of species (m), k⁻¹ is Boltzmann constant (J/mol K); s is specific pore area (m); ε is permittivity of solvent (C²/J-m); R is gas constant (J/mol-K); T is temperature (K); Fa is Faraday constant (C/mol); Zᵢ is valency of ions; Cᵢ is concentration of ions (mol/m³); σₛ is surface charge (C/m²), and e is charge of one electron (C).

13. The method according to claim 11, wherein said determining pI and charge of each particle comprises using the Henderson-Hasselbach equation:
$$p H = p {K}_{a} + log ( \frac{[ A ]}{[ HA ]} ) .$$

14. The method according to claim 11, wherein said determining pI and charge of each particle is carried out using a computer readable program.

15. The method according to claim 11, wherein said selecting the pH of the suspension comprises:
choosing a pH that optimizes the yield, purity, selectivity, and/or diafiltration processing time of polydisperse suspensions and solutions or that is fixed by process requirements other than filtration.

16. The method according to claim 11, wherein said selecting ionic strength of the suspension comprises:
choosing an ionic strength that optimizes the yield, purity, selectivity, and/or diafiltration processing time of polydisperse suspensions and solutions or that is fixed by process requirements other than filtration.

17. The method according to claim 11, wherein said selecting the valency of ions (Zᵢ) in the suspension comprises choosing the (Z) value that optimizes the yield, purity, selectivity, and/or diafiltration processing time of polydisperse suspensions and solutions or that is fixed by process requirements other than filtration.

18. The method according to claim 1, wherein said determining the pressure-independent flux [J_{PI}(i)] for the polydisperse suspension and cake composition comprises:
1) determining the pressure-independent flux for a monodisperse suspension (Jₘᵢ) for a particle “i” using:
$${J}_{m i} = Max [ BD ln ( \frac{{ϕ}_{w}}{{ϕ}_{b}} ) , SID ln ( \frac{{ϕ}_{w}}{{ϕ}_{b}} ) ]$$
where BD=0.114(γk′²T²/n²a²L)^{1/3}, SID=0.078(a⁴/L)^{1/3}, and φ_{w}=0.64 is set as maximum packing volume fraction for monodisperse spheres for each species for a first iteration;
2) determining maximum aggregate packing volume fraction for all particles (φ_{M}) at the membrane wall using φ_{Mn}=φₘ+φₘ(1−φ_{Mn-1}), where φ_{M}=φₘ is set to 0.64 when the size ratio of the particles is >10, such that aᵢ₊₁>10aᵢ for all aᵢ; and
φ_{M}=φₘ+φₘ(1−φₘ)+0.74[1−{φₘ+φₘ(1−φₘ)}]
3) iterating φ_{M} for all particle sizes and selecting the particle that gives the minimum permeation flux at a given wall shear rate (J_{PD}), where (J_{PD}) is obtained by J_{PD}=Min[Jₘ₁, Jₘ₂, . . . , Jₘₙ], where the selected particle has a radius αₘ;
4) determining packing density for other particle sizes (αᵢ for i≠m) at the minimum permeation flux by calculating φ_{wi} from the equation:
$${ϕ}_{wi} = Min [ {ϕ}_{bi} exp ( \frac{{J}_{PD}}{BD} ) , {ϕ}_{bi} exp ( \frac{{J}_{PD}}{SID} ) ] for all i \neq m ;$$
5) checking Σφ_{wi}≦φ_{M} and other packing constraints; and
6) determining a hypothetical pressure-independent flux [J_{PI}(i)] for each particle by:
$${J}_{PI} ( i ) = Max [ BD ln ( \frac{{ϕ}_{wi}}{{ϕ}_{bi}} ) , SID ln ( \frac{{ϕ}_{wi}}{{ϕ}_{bi}} ) ] ,$$
where φ_{wi}=0.74(1−Σφ_{wretained}) using the results of steps 1) to 5), thereby determining pressure-independent permeation flux [J_{PI}(i)])] for the polydisperse suspension and cake composition of the suspension.

19. The method according to claim 18, wherein J_{PI}=J_{PD} for nominally retained particles.

20. The method according to claim 18, wherein J_{PI}≧J_{PD} for transmitted particles.

21. The method according to claim 18, wherein said determining maximum aggregate packing volume fraction (φ_{M}) at the membrane wall comprises:
calculating a maximum radius ratio of all particles;
determining if said maximum radius ratio is <10; and
setting φ_{M} as 0.68, where said maximum radius ratio is <10.

22. The method according to claim 18 further comprising:
reevaluating the estimate of the pressure-independent polydisperse permeation flux of the suspension by correcting packing density using φ_{wicorrected}=φ_{M}[(φ_{wi})/Σφ_{wi}] instead of 0.64; and
repeating steps 1) and 3).

23. The method according to claim 1 further comprising:
re-calculating packing density for all particle sizes if packing constraints are not satisfied based on initial determination of packing densities of the particles at the wall.

24. The method according to claim 1, wherein determining said overall observed sieving coefficient (Sₒ(i)) through the cake deposit and the membrane comprises:
using Sₒ(i)=S_{odeposit}(i)Sₒₘₑₘ(i), where S_{odeposit} (sieving coefficient through the deposit) is
$${S}_{odeposit} ( i ) = 1 - \frac{{J}_{actual}}{{J}_{PI} ( i )}$$
for the ith particle; the sieving coefficient through the membrane Sₒₘₑₘ(i) is obtained from
$${S}_{omem} ( i ) = \frac{{S}_{a}}{( 1 - {S}_{a} ) exp ( \frac{- {J}_{actual}}{k} ) + {S}_{a}} , where$$
mass transfer coefficient (k) is given by
$$k = \frac{{J}_{PI} ( i )}{ln ( \frac{{ϕ}_{wi}}{{ϕ}_{bi}} )} ,$$
where ø_{wi} is particle volume fraction at the membrane wall (−) for particle (i), ø_{bi} is particle volume fraction in bulk solution (−) for particle (i); actual sieving coefficient (Sₐ) is obtained from
$${S}_{a} = \frac{{S}_{∞} exp ( {Pe}_{m} )}{{S}_{∞} + exp ( {Pe}_{m} ) - 1} ,$$
wall Peclet number (Peₘ) is obtained from
$${Pe}_{m} = ( \frac{{J}_{actual} {δ}_{m}}{D} ) ( \frac{{S}_{∞}}{ɛϕ {K}_{d}} ) ,$$
where φK_{d}=(1−λ′)^{9/2} and λ′ is statistical equilibrium partition coefficient (−); and intrinsic sieving coefficient S_{∞} is obtained by S_{∞}=(1−λ′)²[2−(1−λ′)²]exp(−0.7146λ′²).

25. The method according to claim 1, wherein said solving a solute mass balance equation for each solute (i) comprises:
calculating the difference equation for each solute (i) using:
$$\begin{matrix}{ϕ}_{bi 1} ( t + Δ t ) = {ϕ}_{bi 1} ( t ) [ 1 - J ( 1 ) A ( 1 ) {S}_{o 1} ( i ) \frac{Δ t}{V ( 1 )} ] + \\ {ϕ}_{bi 2} ( t ) [ J ( 2 ) A ( 2 ) {S}_{o 1} ( i ) \frac{Δ t}{V ( 1 )} ]\end{matrix}$$
wherein A is membrane area (m²); J is solvent permeation flux (m/s); T is temperature (K); V(1) is the volume of reservoir (1) (m³); ø_{bi1} is the particle volume fraction in the bulk solution (−) for solute particle i in a first reservoir; Sₒ₁(i) is overall observed sieving coefficient through the cake deposit and the membrane in a first reservoir.

26. The method according to claim 1, wherein said solving a solute mass balance equation for each solute (i) in each reservoir (j) comprises:
calculating the difference equation for each solute (i) for n reservoirs and n membranes using:
φ_{bij}(t+Δt)=φ_{bij}(t)+(1/V(j))[Σ(k)φ_{bik}Sₒₖ(i)−Pⱼφ_{bij}Sₒⱼ(i)]Δt, wherein P(k) is permeation rate in m³/s through the kth membrane and wherein k=membrane numbers whose permeate is routed to reservoir (j) and k≠j.

27. The method according to claim 1, wherein the operating conditions determined are optimum for yield of a target species from the crossflow filtration of particles in a polydisperse feed suspension.

28. The method according to claim 1, wherein the operating conditions determined are optimum for the purity of a target species from the crossflow filtration of particles in a polydisperse feed suspension.

29. The method according to claim 1, wherein the operating conditions determined are optimum for selectivity of a target species.

30. The method according to claim 1, wherein the operating conditions determined are optimum for processing time of the crossflow filtration of a target species in a polydisperse feed suspension.

31. The method according to claim 1, wherein crossflow filtration is carried out using ultrafiltration.

32. The method according to claim 1, wherein crossflow filtration is carried out using microfiltration.

33. The method according to claim 1, wherein crossflow filtration is carried out using ultrafiltration and microfiltration.

34. The method according to claim 1, wherein the feed suspension is selected from the group consisting of streams from biomedical and bio-processing industries, waste water, surface water, environmental pollutants, industrial waste streams, and industrial feed streams.

35. The method according to claim 34, wherein the feed suspension is a stream from biomedical and bio-processing industries selected from the group consisting of proteins, cells, nucleic acids, colloids, milk, and suspended particles.

36. The method according to claim 1, wherein optimum operating conditions for yield of a target species, purity of a solute, selectivity of a desired particle, or processing time crossflow membrane filtration of particles comprising one or more desired solutes in a polydisperse feed suspension are determined using a computer readable program.

37. The method according to claim 36, wherein time (t) is an arbitrarily small increment.

38. A computer readable medium having stored thereon programmed instructions for predicting and optimizing operating conditions for yield of a target species, purity of a target species, selectivity of a target species and/or processing time for crossflow membrane filtration of a polydisperse feed suspension comprising one or more target solute or particle species, said medium comprising:
a machine executable code which, when provided as input parameters: size distribution of the particles and solutes in the suspension, concentration of particles and solutes in the suspension, suspension pH and temperature, membrane thickness, membrane hydraulic permeability (Lp), membrane pore size or molecular weight cut off, membrane module internal diameter, membrane module length, membrane area, membrane porosity, filtration system configuration, and reservoir volume (V); and executed by at least one processor, causes the processor to calculate the effective membrane pore size distribution (λ′), viscosity of the suspension, hydrodynamics of the suspension, electrostatics of the suspension, pressure-independent permeation flux (J_{PD}) of the suspension and cake composition, pressure-independent permeation flux [J_{PI}(i)] for each particle (i) in the suspension, and overall observed sieving coefficient of each target solute or particle species through cake deposit and pores of the membrane using said provided input parameters; and solve a solute mass balance equation for each target solute or particle species in each reservoir of the feed suspension based on said provided size distribution of the particles and solutes in the suspension, concentration of particles and solutes in the suspension, suspension pH and temperature, membrane thickness, membrane hydraulic permeability, membrane pore size or molecular weight cut off, membrane module internal diameter, membrane module length, membrane area, membrane porosity, filtration system configuration, and reservoir volumes, and said calculated effective membrane pore size distribution (λ′), viscosity of the suspension, hydrodynamics of the suspension, electrostatics of the suspension, pressure-independent permeation flux (JPD) of the suspension and cake composition, pressure-independent permeation flux [J_{PI}(i)] for each particle (i) in the suspension, and overall observed sieving coefficient of a particle through cake deposit and pores of the membrane; iterate the solute mass balance equation for each species at all possible permeation fluxes to determine time, yield, selectivity, and processing time of crossflow filtration; analyze the results of the mass balance equations and predict the operating conditions that optimize for yield of a target species, selectivity of a target species, purity of a target species, and/or processing time, thereby predicting and optimizing operating conditions for crossflow membrane filtration of a polydisperse feed suspension comprising one or more target solute or particle species.

39. A storage system containing the computer readable medium according to claim 38.
